(19) United States
(12) Patent Application Publication
(10) Pub. No.: US 2024/0128549 A1
(43) Pub. Date: Apr. 18, 2024

(54) ELECTRODE CONFIGURATIONS FOR IRON-AIR ELECTROCHEMICAL SYSTEMS

(71) Applicant: Form Energy, Inc.

(72) Inventors: Joseph Stephen Manser, Lowell, MA (US); Christopher Thomas Reynolds, Arlington, MA (US); Karen Thomas-Alyea, Arlington, MA (US); Michael Chon, Medford, MA (US); David Hooke, Somerville, MA (US); Michael Andrew Gibson, Somerville, MA (US); Yuto Takagi, Natick, MA (US); Johanna Goodman, Lincoln, MA (US); Robert Wesley Morgan, Arlington, MA (US); Valerie Christine Sacha, Cambridge, MA (US); Angel Ruben Rivera, Watertown, MA (US); Joseph Anthony Pantano, Canton, MA (US); Julia Sokol, Cambridge, MA (US); Nicholas Reed Perkins, Somerville, MA (US)

(21) Appl. No.: 18/485,804

(22) Filed: Oct. 12, 2023

Related U.S. Application Data
(60) Provisional application No. 63/379,223, filed on Oct. 12, 2022.

(51) Int. Cl. H01M 12/06; H01M 4/52; H01M 50/138

(52) U.S. Cl. CPC H01M 12/06; H01M 4/52; H01M 50/1385

(57) ABSTRACT

An iron-air battery including an iron electrode in contact with an anode current collector, wherein the iron electrode includes a plurality of channels; an oxygen reduction reaction electrode having a first surface facing the plurality of channels and an opposing second surface in contact with air; an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode; and an electrolyte in contact with the iron electrode, the first surface of the oxygen reduction reaction electrode, the plurality of channels, and the oxygen evolution reaction electrode.

### CROSS REFERENCE TO RELATED APPLICATIONS

This application claims priority to U.S. provisional application No. 63/379,223, filed on Oct. 12, 2022, and all the benefits accruing therefrom under 35 U.S.C. § 119, the entire content of which is incorporated herein by reference.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

Iron-containing negative-electrode electrochemical systems (or said another way, iron-containing-anode electrochemical systems) are attractive options for electrochemical energy storage. There exists a need to improve the design and composition of electrochemical systems having iron-containing materials, such as iron-containing negative electrodes, to enhance the performance of such systems.

### BRIEF DESCRIPTION

Provided is an iron-air battery, including an iron electrode in contact with an anode current collector, wherein the iron electrode comprises a plurality of channels; an oxygen reduction reaction electrode having a first surface facing the plurality of channels and an opposing second surface in contact with air; an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode; and an electrolyte in contact with the iron electrode, the first surface of the oxygen reduction reaction electrode, the plurality of channels, and the oxygen evolution reaction electrode.

Provided is an iron-air battery, including an iron electrode comprising a plurality of anodes separated by a plurality of channels, wherein the plurality of anodes are in electrical communication with each other; an oxygen reduction reaction electrode having a first surface facing the plurality of channels and an opposing second surface in contact with air; an oxygen evolution reaction electrode interdigitated with the plurality of channels, wherein at least a portion of the oxygen evolution reaction electrode is disposed within the plurality of channels in a direction perpendicular to a plane of the oxygen reduction reaction electrode; and an electrolyte in contact with the iron electrode, the first surface of the oxygen reduction reaction electrode, the plurality of channels, and the oxygen evolution reaction electrode.

Provided is an iron-air battery including an iron electrode comprising a plurality of anodes separated by a plurality of channels, wherein the plurality of anodes is in electrical communication with each other; an oxygen reduction reaction electrode having a first surface facing the plurality of channels and an opposing second surface in contact with air; an oxygen evolution reaction electrode comprising a plurality of cathodes interdigitated with the plurality of anodes, wherein the plurality of cathodes is disposed within the plurality of channels in a direction perpendicular to a plane of the oxygen reduction reaction electrode, and wherein the plurality of cathodes is in electrical communication with each other; and an electrolyte in contact with the iron electrode, the first surface of the oxygen reduction reaction electrode, the plurality of channels, and the oxygen evolution reaction electrode.

Provided is an iron-air battery including an iron electrode in contact with an anode current collector, wherein the iron electrode comprises a plurality of channels; an oxygen reduction reaction electrode having a first surface facing the plurality of channels and an opposing second surface in contact with air; an oxygen evolution reaction electrode comprising a plurality of cathodes interdigitated with the iron electrode, wherein the plurality of cathodes is disposed within the plurality of channels in a direction perpendicular to a plane of the oxygen reduction reaction electrode, and wherein the plurality of cathodes is in electrical communication with each other; and an electrolyte in contact with the iron electrode, the first surface of the oxygen reduction reaction electrode, the plurality of channels, and the oxygen evolution reaction electrode.

Provided is an iron-air battery including an iron electrode in contact with an anode current collector, wherein the iron electrode and the anode current collector are arranged in a spiral configuration; an oxygen reduction reaction electrode having a first surface facing an axis of rotation of the spiral configuration and an opposing second surface in contact with air; an oxygen evolution reaction electrode arranged in a spiral configuration and interdigitated with the iron electrode, wherein the iron electrode and the oxygen evolution reaction electrode are at least partially bifilar; and an electrolyte in contact with the iron electrode, the first surface of the oxygen reduction reaction electrode, and the oxygen evolution reaction electrode.

Provided is an iron-air battery including an iron electrode in contact with an anode current collector, wherein the iron electrode and the anode current collector are arranged in a pleated configuration, and wherein the iron electrode includes a plurality of channels between the pleats; an oxygen reduction reaction electrode having a first surface facing the plurality of channels and an opposing second surface in contact with air; an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode, and wherein the oxygen evolution reaction electrode is arranged in a pleated configuration; and an electrolyte in contact with the iron electrode, the first surface of the oxygen reduction reaction electrode, the plurality of channels, and the oxygen evolution reaction electrode.

Provided is a method of forming an iron-air battery including forming an iron negative electrode material onto an anode current collector to form the iron electrode including a plurality of channels; disposing the oxygen evolution reaction electrode into one or more channels of the iron electrode; and assembling the oxygen reduction reaction electrode having the first surface facing the iron electrode and the opposing second surface in contact with air to form an electrode assembly.

The above described and other features are exemplified by the following figures and detailed description.

### BRIEF DESCRIPTION OF THE DRAWINGS

The following figures are exemplary embodiments wherein the like elements are numbered alike.

FIG. 1 is a schematic cross-sectional view of an iron-air battery;

FIG. 2 is a schematic cross-sectional view of an iron-air battery according to one or more embodiments;

FIG. 3 is a schematic cross-sectional view of an iron-air battery according to one or more embodiments;

FIG. 4 is a schematic cross-sectional view of an iron-air battery according to one or more embodiments;

FIG. 5 is a schematic cross-sectional view of an iron-air battery according to one or more embodiments;

FIG. 6 is a schematic cross-sectional view of an iron-air battery according to one or more embodiments;

FIG. 7 is a schematic cross-sectional view of an iron-air battery according to one or more embodiments;

FIG. 8 is a perspective view of the iron-air battery of FIG. 7 according to one or more embodiments;

FIG. 9 is a schematic cross-sectional view of an iron-air battery according to one or more embodiments;

FIG. 10 is a schematic cross-sectional view of an iron-air battery according to one or more embodiments;

FIG. 11 is a perspective view of an iron-air battery of FIG. 10 according to one or more embodiments;

FIG. 12 is a schematic cross-sectional view of an iron-air battery according to one or more embodiments;

FIG. 13 is a schematic cross-sectional view of an iron-air battery according to one or more embodiments;

FIG. 14 is a schematic cross-sectional view of an iron-air battery according to one or more embodiments;

FIG. 15 is a schematic cross-sectional view of an iron-air battery according to one or more embodiments;

FIG. 16 is a perspective view of an iron-air battery according to one or more embodiments;

FIG. 17 is a perspective view of an iron-air battery according to one or more embodiments;

FIG. 18 shows an exemplary method for preparing an iron-air battery according to one or more embodiments;

FIG. 19 is a graph of Coulombic efficiency (%) versus charge time (hours, h) according to one or more embodiments;

FIG. 20 is a graph of area-specific resistance (ohm square centimeters, Ω cm²) versus time (h) according to one or more embodiments;

FIG. 21 is a graph of Coulombic efficiency (%) versus charge time (h) according to one or more embodiments;

FIG. 22 is a graph of area-specific resistance (S) cm²) versus time (h) according to one or more embodiments;

FIG. 23 is a graph of Coulombic efficiency (%) versus charge time (h) according to one or more embodiments;

FIG. 24 is a graph of area-specific resistance (S) cm²) versus time (h) according to one or more embodiments;

FIG. 25 is a graph of Coulombic efficiency (%) versus charge time (h) according to one or more embodiments; and

FIG. 26 is a graph of area-specific resistance (S) cm²) versus time (h) according to one or more embodiments; and

FIG. 27 is a graph of cell voltage (Volts, V) versus capacity (ampere hours, Ah) according to one or more embodiments.

### DETAILED DESCRIPTION

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

Metal-air batteries are electrochemical cells that include a metal anode, a cathode that is exposed to air, and an aqueous or aprotic or solid state electrolyte. During discharging of a metal-air battery, a reduction reaction occurs in the cathode and the metal anode is oxidized. Recently, interest in developing iron-air batteries has increased, due to iron-air batteries having the potential to provide grid-scale energy storage. In addition, the main raw material of iron-air batteries is iron oxide, which is an abundant, inexpensive, non-toxic, and economical material.

Half-cell reactions on an iron anode that occur during discharge and oxidation in an alkaline electrolyte are as provided by Equations 1 and 2:

Fe+2OH⁻⇄Fe(OH)₂+2e⁻ (Equation 1)

3Fe(OH)₂+2OH⁻⇄Fe₃O₄+4H₂O+2e⁻ (Equation 2)

In Equation 1, iron hydroxide may be formed on the surface of iron forming the iron electrode 120. In Equation 2, the iron hydroxide is subsequently oxidized further to form magnetite. There is a net volume increase upon discharge that is taken up in the porosity of the iron anode 120. The theoretical capacity based on metallic iron according to the anode reactions in this example is 960 milliampere hours per gram (mAh/g) of Fe in step 1, 320 mAh/g of Fe in Equation 2.

Iron anodes may be difficult to recharge due to competition with hydrogen (H 2) evolution, a side reaction that does not lead to recharging of the cell, because electrons are diverted to H₂ rather than stored in a more reduced iron-bearing negative electrode. Additionally, the ability of electrons or ions to move through a thick iron anode may also hinder the charge and discharge reactions. When there is no, or a limited, pathway to move electrons or ions through the anode, the efficiency of charge and discharge of the anode may decrease. Accordingly, there is a need for improved iron-air batteries.

To reduce the materials cost of iron-air batteries, it may be desirable to have iron electrodes with high areal capacity, i.e., thick iron electrodes. Assuming the cost of the air electrode may be fixed, a thicker iron electrode may mean the materials cost for the air electrode is divided by a larger cell energy. However, thicker iron electrodes may have lower coulombic efficiency and lower voltage efficiency compared with thinner iron electrodes. Therefore, designs of iron electrodes, such as thicker iron electrodes, which can provide high areal capacity with improved coulombic and voltage efficiency may be beneficial.

Thicker iron electrodes have lower voltage efficiency because thicker iron electrodes have higher ionic resistance. Thicker iron electrodes have higher resistance because ions in the electrolyte must travel farther to reach the back of the electrode.

Hydrogen evolution can occur as a side reaction on the iron electrode, which causes the coulombic efficiency to be less than 100%. Thicker iron electrodes may have lower coulombic efficiency because current follows the path of least resistance. It is lower resistance to evolve hydrogen at the front of the electrode, than for ionic current to travel to the back of the thick iron electrode.

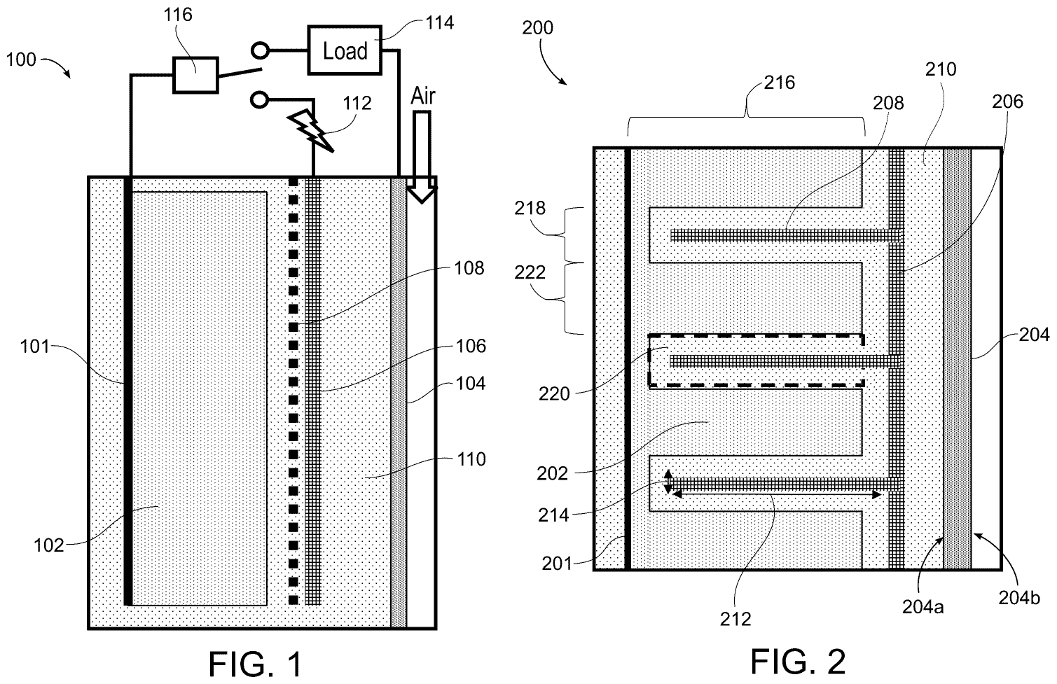

An iron-air electrochemical cell is shown in FIG. 1, which includes a dual-electrode configuration. As used herein, the term “dual-electrode configuration” refers to an iron-air battery having separate positive electrodes for charging and discharging. When oxygen is the reactant at the positive electrode, it can be advantageous to have separate electrodes for discharging and for charging. Referring to FIG. 1, an iron-air electrochemical cell 100 is provided. The iron-air cell 100 includes a current collector 101, an iron electrode 102 (anode) disposed on the current collector 101, an oxygen reduction reaction (ORR) electrode 104, and an oxygen evolution reaction (OER) electrode 106. The iron-air cell 100 may further include a separator 108 that is disposed between the iron electrode 102 and the OER electrode 106. The separator 108 may include a compression frame, a porous insulator, and/or a ribbed structure to facilitate bubble egress from the iron electrode 102. For example, the separator 108 may be a porous dielectric coating formed on the iron electrode 102 and/or the OER electrode 106. The iron-air electrochemical cell further includes an electrolyte 110 that is in contact with the iron electrode, a first surface of the ORR electrode 104, and the OER electrode 106. Suitable electrolytes are further described herein.

During charging of the iron-air electrochemical cell 100, the OER electrode 106 and the iron electrode 102 may be electrically connected to a power source 112, such that iron species of the iron electrode 102 are reduced to form metallic iron, Fe(0). During discharging of the iron-air electrochemical cell 100, the ORR electrode 104 and the iron electrode 102 may be electrically connected to a load 114, such that metallic iron Fe(0) of the iron electrode 102 is oxidized to form higher valence iron species such as Fe₃O₄. The iron-air electrochemical cell 100 may be further configured to include a switch 116 to allow electrical connection between the iron electrode 102 and the power source 112, or to allow electrical connection between the iron electrode 102 and the load 114.

The coulombic efficiency of the iron electrode during charging may be affected by the configuration of the electrode used for charging. Applicants have discovered that the coulombic efficiency can be improved by reducing the distance through which ions must travel through the iron electrode to reach un-reacted oxidized iron species within. Various embodiments described herein provide iron-containing anodes and OER electrodes with an interdigitated or channeled design to provide higher voltage efficiency and higher coulombic efficiency than simple planar electrode arrangements, such as those shown in FIG. 1. For example, in any porous iron electrode, there may be competing needs for ionic transport (which may be better with higher porosity) and electrical transport across particle-particle contacts (which may usually be better with lower porosity). Without wishing to be bound to theory, a key advantage of interdigitated or channeled electrode design may be that these two functions are decoupled: ionic transport occurs in the channels, while good electrical contact between particles of active material can occur in the lower-porosity features of the iron-containing anode.

According to an aspect, provided is an iron-air battery including an iron electrode that is in contact with an anode current collector, wherein the iron electrode includes a plurality of channels. The iron-air battery includes an oxygen reduction reaction (ORR) electrode that has a first surface facing the plurality of channels and an opposing second surface in contact with air. The iron-air battery includes an oxygen evolution reaction (OER) electrode interdigitated with the plurality of channels of the iron electrode, wherein at least a portion of the oxygen evolution reaction electrode is disposed within the plurality of channels in a direction that is perpendicular to a plane of the oxygen reduction reaction electrode. The iron-air battery also includes an electrolyte in contact with the iron electrode, the first surface of the ORR electrode, the plurality of channels, and the OER electrode.

FIG. 2 shows one or more embodiments of an iron-air battery 200. The iron-air battery 200 includes an iron electrode 202 that is in contact with an anode current collector 201. As shown in FIG. 2, the iron-air battery 200 includes a plurality of channels 220 disposed therein. The channels 220 may have any suitable shape, such as rectangular prism, cylindrical, a pyramidal shape, a trapezoidal prism shape, or the like when viewed from the cross-section. Each channel 220 may have the same shape or a different shape.

In the iron electrode 202, one or more channels of the plurality of channels 220 may have an average length 216 that is 3 mm to 50 mm in a direction perpendicular to the plane of the ORR electrode 204. For example, one or more channels of the plurality of channels 220 may have an average length 216 that is 15 mm to 35 mm, or 15 to 30 mm, or 15 to 25 mm in a direction perpendicular to the plane of the ORR electrode 204.

In the iron electrode 202, one or more channels of the plurality of channels 220 may have an average width 218 that is 1 mm to 40 mm in a direction parallel to the plane of the ORR electrode 204. For example, one or more channels of the plurality of channels 220 may have an average width that is 2 mm to 30 mm, or 2 to 20 mm, or 2 to 15 mm in a direction parallel to the plane of the ORR electrode 204.

In the iron electrode 202, one or more channels of the plurality of channels 220 may be separated from each other by an average distance 222 that is 10 mm to 50 mm in a direction parallel to the plane of the ORR electrode 204, when measured between centers of adjacent channels. For example, one or more channels of the plurality of channels 220 may be separated from each other by an average distance 222 that is 10 mm to 30 mm, or 10 mm to 20 mm in a direction parallel to the plane of the ORR electrode 204, when measured between centers of adjacent channels.

In some embodiments, and as further described herein, the plurality of channels may be oriented perpendicular to the plane of the ORR electrode, i.e., may have a channel width that is constant across the thickness of the electrode. Alternatively, the plurality of channels may be sloped. If the plurality of channels is sloped, the channels may be wider at the side facing the ORR electrode, as described herein. In other embodiments, if the plurality of channels is sloped, the slope may be the inverse with the channels narrower at the side facing the ORR electrode. The plurality of channels may be oriented vertically to allow for hydrogen evolution reaction (HER)/oxygen evolution reaction (OER) bubble egress out of the top of the cell, as shown below. In other embodiments, the channel may be horizontal, cross hatched, or the like.

In FIG. 2, the iron-air battery 200 includes an ORR electrode 204 having a first surface 204a facing the plurality of channels 220 and an opposing second surface 204b in contact with air. The ORR electrode 204 may be as defined herein.

In FIG. 2, the iron-air battery 200 includes an OER electrode 206 that is interdigitated with the plurality of channels 220 of the iron electrode 202, wherein at least a portion of the OER electrode 206 is disposed within the plurality of channels 220 in a direction perpendicular to a plane of the ORR electrode 204. In other words, the OER electrode 206 has portions that are disposed in the channels 220 in a direction that is perpendicular to the first surface 204a of the ORR electrode 204.

The iron electrode 202 may include a spine portion that is parallel to the current collector 201 that connects protruding portions of the iron electrode 202 that define the plurality of channels 220. Such protruding portions of the iron electrode 220 may be referred to herein as the “ribs”, whereas the non-protruding portions of the iron electrode 220 may be referred to herein as the “spine”. The spine portion may include an electrolyte volume fraction that is from 2 volume percent (vol %) to 20 vol %, such as 5 vol % to 15 vol %, lower than that of the rib portions. The spine portion and the rib portions may be formed of the same iron-containing material. The thickness of the spine portion may be 10% to 50% of the thickness of the rib portions, where the thickness direction is defined as parallel to the plurality of channels 220.

In some embodiments, the spine portion may have a higher density and/or lower porosity than the rib portions. For example, the porosity of the spine portion may be at least 5 vol % less than a porosity of the rib portions. The bonding of the electrode material in the spine portion to a denser current collector may improve adhesion. Additionally, the spine portion is thinner than the rib portions, and so there may be a reduced need for obtaining high ionic transport in the spine portion relative to the remainder of the iron electrode. As such, higher degrees of compaction and/or lower porosity may be desirable in the spine portion relative to the rib portions. The porosity/compaction gradients may be continuous or may include discrete changes in porosity/compaction. The gradient in porosity may result from the manufacturing method employed.

In other embodiments, the spine portion and the rib portions may have substantially the same porosity and/or density (e.g., powder microstructure of the spine portion and the rib portions may be uniform) in the fully charged and fully discharged states. For example, the porosity/density of the spine portion may be within +/−5% of the porosity/density of the rib portions. This design may provide for uniform transport resistance in all regions of the iron electrode. Electrodes with non-uniform resistance may have worse coulombic efficiency. Uniform electrode porosity may be achieved by sintering of packed electrode powders, metal injection molding, or any suitable methods common in the art for assembling a mass of powder material and thermally or mechanically bonding it together uniformly, as further described below. In some instances, a gelled powder mass may be coated into the shape, dried, and then processed to form the iron electrode. In some embodiments, the bonding of the powder may take place through electrochemical sintering, rather than through mechanically driven and/or thermally driven consolidation. In some embodiments, the bonding of the powder may take place through combination with a binder material, such as a polymer binder, and then extruding, compacting, or otherwise forming the iron electrode.

In FIG. 2, the iron-air battery 200 also includes an electrolyte 210 that is in contact with the iron electrode 202, the first surface 204a of the ORR electrode 204, the plurality of channels 220, and the OER electrode 206. The electrolyte 210 is as described herein.

In some embodiments, the iron-air battery 200 may also include a separator (not shown) that is disposed between at least a portion of the iron electrode 202 and the OER electrode 206. For example, the separator may be disposed along each of the channels 220 of the iron electrode 202. The separator materials may be as described herein. In some embodiments, the region between the negative electrode and the OER electrode may include a frame for compression, a porous insulator as a separator, and/or ribbed structures to facilitate bubble egress. These features and materials are further described herein.

As shown in FIG. 2, the OER electrode 206 may include a trunk portion that is disposed between the iron electrode 202 and the ORR electrode 204, and a plurality of cathode projections 208 that extend from the trunk portion and are disposed within the plurality of channels 220 of the iron electrode 202. The trunk portion of the OER electrode 206 is not interdigitated with the plurality of channels 220 of the iron electrode 202. For example, the trunk portion of the OER electrode 206 may be parallel to the ORR electrode 204. The cathode projections 208 may have any suitable shape, and may be, for example, rectangular prism (e.g., box-shaped), triangular (e.g., pyramidal), trapezoidal prism, ellipsoidal (e.g., cylindrical), or the like, in cross-section.

In some embodiments, the plurality of cathode projections 208 may have an average length 212 of 3 millimeters (mm) to 50 mm when measured from the trunk portion. For example, the plurality of cathode projections 208 may have an average length 212 of 5 mm to 35 mm, or 10 mm to 30 mm when measured from the trunk portion. In some embodiments, the plurality of cathode projections 208 may have a width that is 0.1 mm to 20 mm, or 0.5 mm to 15 mm, when measured in a direction parallel to the trunk portion.

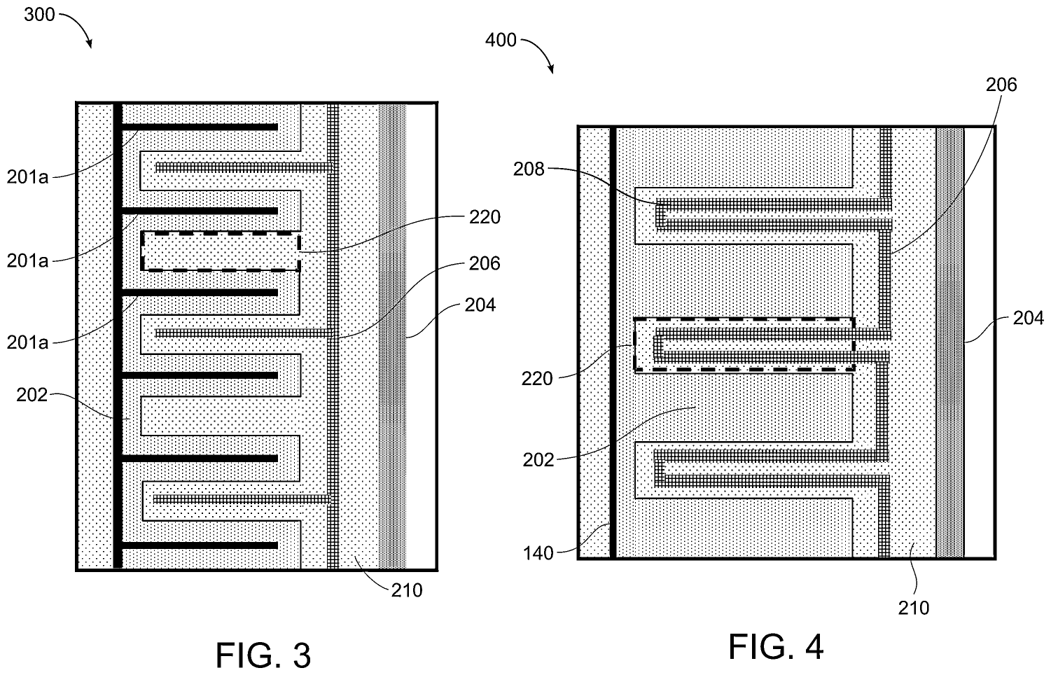

In some embodiments, greater than 25% of channels of the iron electrode include the OER electrode disposed therein. That is, some of the channels of the iron electrode may include the OER electrode, and some of the channels of the iron electrode may not include the OER electrode. As shown in FIG. 3, one or more channels 220 may be devoid of an OER electrode 206, where the OER electrode 206 is found in a portion of the channels 220 of the iron electrode 202. For example, greater than 40%, or greater than 50%, or greater than 60% of channels of the iron electrode may include the OER electrode disposed therein.

In some embodiments, one or more channels of the plurality of channels in FIG. 2 may further include an additive, as described herein. In some embodiments, a channel may include an additive without including an OER electrode disposed therein. In other embodiments, a channel may include both an additive and an OER electrode disposed therein.

The OER electrode may be bent or folded to follow the contours of the iron electrode, such that the branches of the OER electrode are disposed within the plurality of channels of the iron electrode in close proximity. In some embodiments, the iron-air battery may include an OER electrode that is arranged in a corrugated configuration within the plurality of channels. As shown in FIG. 4, the OER electrode 206 may be arranged in a corrugated configuration within the plurality of channels 220. In the corrugated configuration, the plurality of cathode projections 208 are disposed in a continuous manner that extends into the plurality of channels 220 from the trunk portion if the OER electrode 206, rather than as projections from a core trunk portion.

Referring now to FIG. 3, the iron-air battery 300 may include a current collector 201 that further includes one or more branch current collectors 201a disposed parallel to the plurality of channels 220, in a direction perpendicular to the ORR electrode 204. In this arrangement, a primary current collector 201 is connected to the one or more branch current collectors 201a, where the primary current collector is disposed parallel to the ORR electrode 204. Although the branch current collectors 201a are shown in conjunction with one more other feature in FIG. 3, it is contemplated that one or more branch current collectors 201a may be disposed within the iron electrode 202 in one or more portions that are parallel to the plurality of channels 220.

The plurality of channels may be sloped (e.g., have a V-shaped or trapezoidal cross-section and sidewalls that extend in planes that are not perpendicular to planes of the first and/or second ORR electrodes. An alternative configuration may include negatively sloped sidewalls of the channels (e.g., having an inverted V-shaped or trapezoidal cross-section and sidewalls that extend in planes that are not perpendicular to planes of the first and/or second ORR electrodes). However, in other embodiments, the channels may be non-sloped (e.g., may have a rectangular cross-section and sidewalls that extend in a plane orthogonal to the plane of the first and/or second ORR electrodes).

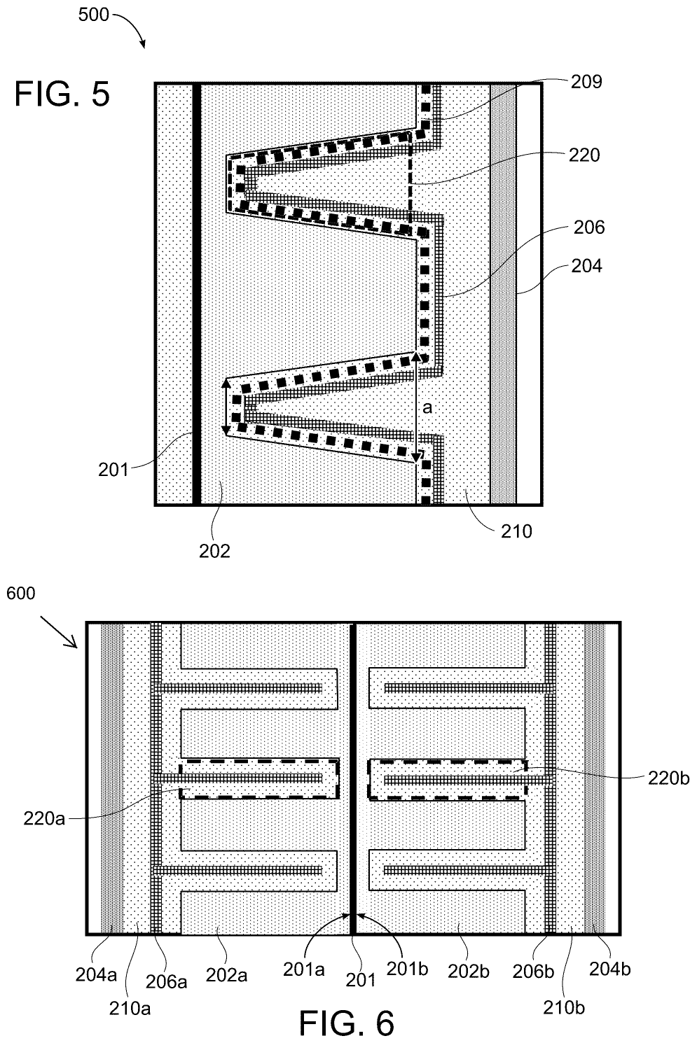

In some embodiments, the one or more channels may have a trapezoidal shape, as exemplified in FIG. 5. In FIG. 5, the width of the channels 220 when measured at a point closest to the ORR electrode 204 are wider than the width of the channels 220 when measured at a point furthest from the ORR electrode 204. For example, one or more channels of the plurality of channels 220 may have an average width of 1 mm to 40 mm in a direction parallel to the plane of the ORR electrode 204, wherein a first width “a” that is closest to the ORR electrode is 1% to 500% greater than a second width “b” that is furthest from the ORR electrode.

FIG. 5 further illustrates an embodiment where the iron-air battery 500 further includes a separator 209 disposed between at least a portion of the iron electrode 202 and the OER electrode 206. It should be noted that a separator may be included in any of the embodiments that are described herein, wherein the separator is disposed between at least a portion of the iron electrode and the OER electrode. The separator is as described herein.

FIG. 5 shows the OER electrode 206 that is arranged in a corrugated configuration within the plurality of channels 220. However, other configurations for the OER electrode 206 are contemplated, including a plurality of OER electrode branches that project from a central OER electrode trunk portion.

In some embodiments, a central anode current collector may have an iron electrode disposed on either side thereof to provide an electrochemical cell that is duplicated across the anode current collector. As shown in FIG. 6, an anode current collector 201 may include a first surface 201a and an opposite second surface 201b. The iron electrode may include a first iron electrode 202a on the first surface 201a of the current collector 201, and a second iron electrode 202a on the second surface 201b of the current collector 201, wherein the first iron electrode 202a includes a first plurality of channels 220a and the second iron electrode 202b includes a second plurality of channels 220b.

In FIG. 6, the ORR electrode (a first ORR electrode) 204a has a first surface facing the first plurality of channels 220a and an opposing second surface in contact with air. In addition, the iron-air battery 600 further includes a second ORR electrode 204b having a first surface facing the second plurality of channels 220b and an opposing second surface in contact with air. The first and second ORR electrodes 204a, 204b may be disposed on opposing sides of, and equidistant from, the iron electrode.

In FIG. 6, the OER electrode (a first OER electrode) 206a is interdigitated with the first plurality of channels 220a of the first iron electrode 202a, wherein at least a portion of the OER electrode 206a is disposed within the first plurality of channels 220a in a direction that is perpendicular to the plane of the first ORR electrode 204a. In addition, the iron-air battery 600 further include a second OER electrode 206b interdigitated with the second plurality of channels 220b of the second iron electrode 202b, wherein at least a portion of the second OER electrode 206b is disposed within the second plurality of channels 220b in a direction perpendicular to a plane of the second ORR electrode 204b.

In FIG. 6, the iron-air battery 600 also includes an electrolyte (a first electrolyte) 210a that is in contact with the first iron electrode 202a, the first surface of the first ORR electrode 204a, the first plurality of channels 220a, and the first OER electrode 206a. The first electrolyte 210a is as described herein. The iron-air battery 600 further includes a second electrolyte 210b that is in contact with the second iron electrode 202b, the first surface of the second ORR electrode 204b, the second plurality of channels 220b, and the second OER electrode 206b. The second electrolyte 210b is as described herein. The first electrolyte and the second electrolyte are the same or different.

The first and second plurality of channels 220a, 220b may be aligned with one another across the current collector 201, as shown in FIG. 6. However, in other embodiments, the first and second plurality of channels 220a, 220b may be offset from one another, with respect to the current collector 201.

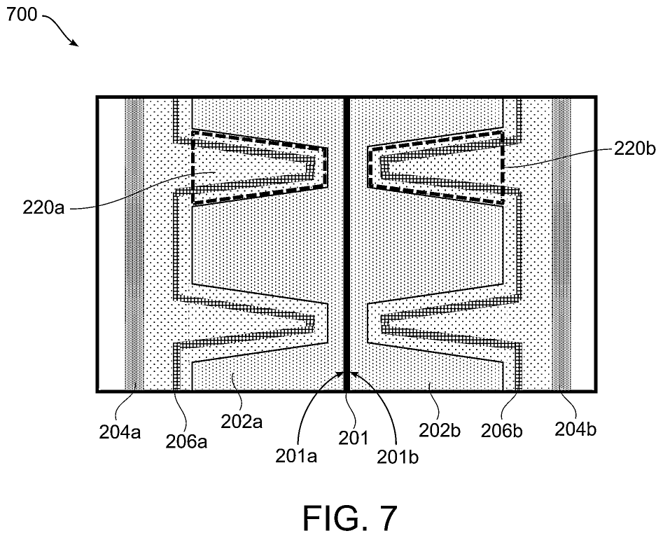

The plurality of channels may have other geometries besides rectangular prism. As shown in FIG. 7, an anode current collector 201 may include a first surface 201a and an opposite second surface 201b. The iron electrode may include a first iron electrode 202a on the first surface 201a of the current collector 201, and a second iron electrode 202a on the second surface 201b of the current collector 201, wherein the first iron electrode 202a includes a first plurality of channels 220a and the second iron electrode 202b includes a second plurality of channels 220b.

In FIG. 7, the ORR electrode (a first ORR electrode) 204a has a first surface facing the first plurality of channels 220a and an opposing second surface in contact with air. In addition, the iron-air battery 600 further includes a second ORR electrode 204b having a first surface facing the second plurality of channels 220b and an opposing second surface in contact with air.

In FIG. 7, the OER electrode (a first OER electrode) 206a is interdigitated with the first plurality of channels 220a of the first iron electrode 202a, wherein at least a portion of the OER electrode 206a is disposed within the first plurality of channels 220a in a direction that is perpendicular to the plane of the first ORR electrode 204a. In addition, the iron-air battery 600 further include a second OER electrode 206b interdigitated with the second plurality of channels 220b of the second iron electrode 202b, wherein at least a portion of the second OER electrode 206b is disposed within the second plurality of channels 220b in a direction perpendicular to a plane of the second ORR electrode 204b.

The first and second plurality of channels 220a, 220b may be aligned with one another across the current collector 201, as shown in FIG. 7. However, in other embodiments, the first and second plurality of channels 220a, 220b may be offset from one another, with respect to the current collector 201.

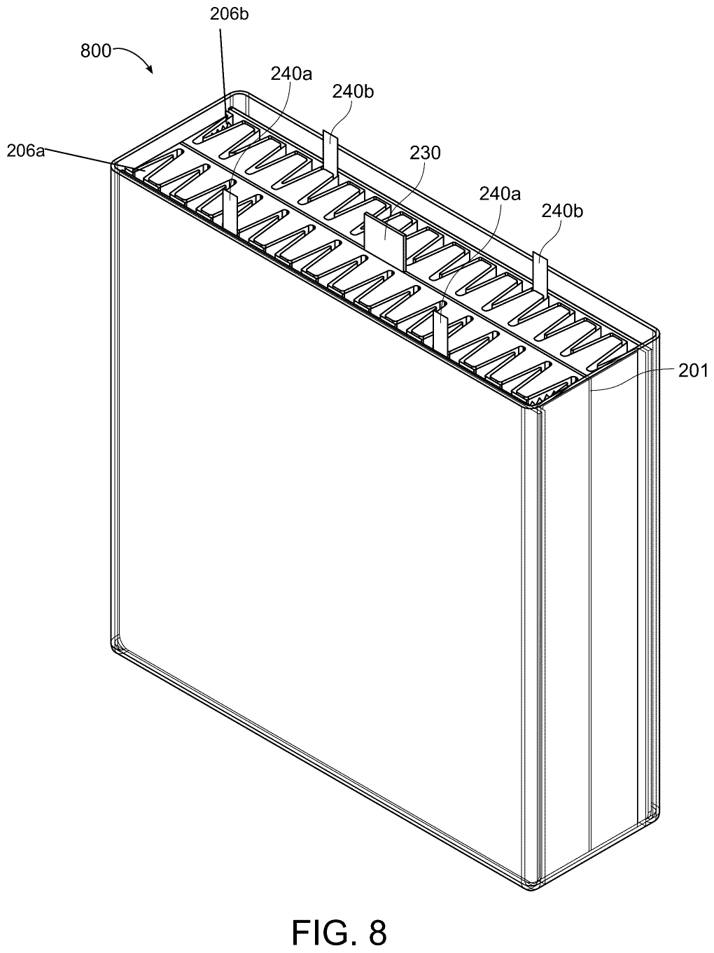

FIG. 8 is an isometric view of an iron-air battery of FIG. 7. In FIG. 8, an anode tab 230 is shown connected to the current collector 201. In addition, cathode tabs 240a are shown connected to the first OER electrode 206a, and cathode tabs 240b are shown connected to the second OER electrode 206b.

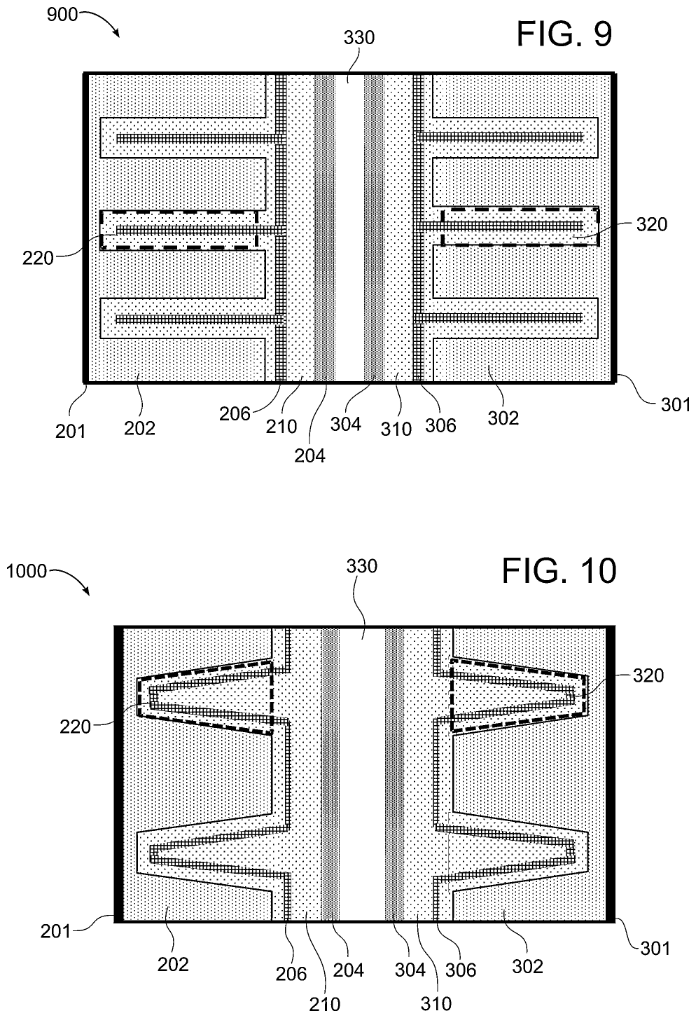

In some embodiments, a plurality of electrochemical cells may be arranged so that a central channel between cells may be in contact with air. As shown in FIG. 9, the iron-air battery of FIG. 2 may be duplicated across an air channel that flows between cells. The iron-air battery 900 further includes a second iron electrode 302 in contact with a second anode current collector 301, wherein the second iron electrode 302 includes a second plurality of channels 320. The iron-air battery 900 includes a second ORR electrode 304 having a first surface facing the second plurality of channels 320 and an opposing second surface in contact with air. As noted above, an air channel 330 is disposed between the second surface of the first ORR electrode 204 and the second surface of the second ORR electrode 304.

In FIG. 9, a second OER electrode 306 is interdigitated with the second plurality of channels 320 of the second iron electrode 302, wherein at least a portion of the second OER electrode 306 is disposed within the second plurality of channels 320 in a direction that is perpendicular to a plane of the second ORR electrode 304.

The iron-air battery 900 further includes a second electrolyte 310 that is in contact with the second iron electrode 302, the first surface of the second ORR electrode 304, the second plurality of channels 320, and the second OER electrode 306. The (first) electrolyte 210 may be the same or different from the second electrolyte 310. In some embodiments, the first electrolyte and the second electrolyte may be in fluid communication with each other.

As described herein, the plurality of channels may have other geometries besides rectangular prism, where a plurality of electrochemical cells is arranged so that a central channel between cells may be in contact with air. As shown in FIG. 10, the iron-air battery of FIG. 5 may be duplicated across an air channel that flows between cells. The iron-air battery 1000 further includes a second iron electrode 302 in contact with a second anode current collector 301, wherein the second iron electrode 302 includes a second plurality of channels 320. The iron-air battery 1000 includes a second ORR electrode 304 having a first surface facing the second plurality of channels 320 and an opposing second surface in contact with air. An air channel 330 is disposed between the second surface of the first ORR electrode 204 and the second surface of the second ORRR electrode 304.

In FIG. 10, a second OER electrode 306 is interdigitated with the second plurality of channels 320 of the second iron electrode 302, wherein at least a portion of the second OER electrode 306 is disposed within the second plurality of channels 320 in a direction that is perpendicular to a plane of the second ORR electrode 304.

The iron-air battery 1000 further includes a second electrolyte 310 that is in contact with the second iron electrode 302, the first surface of the second ORR electrode 304, the second plurality of channels 320, and the second OER electrode 306. The (first) electrolyte 210 may be same or different from the second electrolyte 310. In some embodiments, the first electrolyte and the second electrolyte may be in fluid communication with each other.

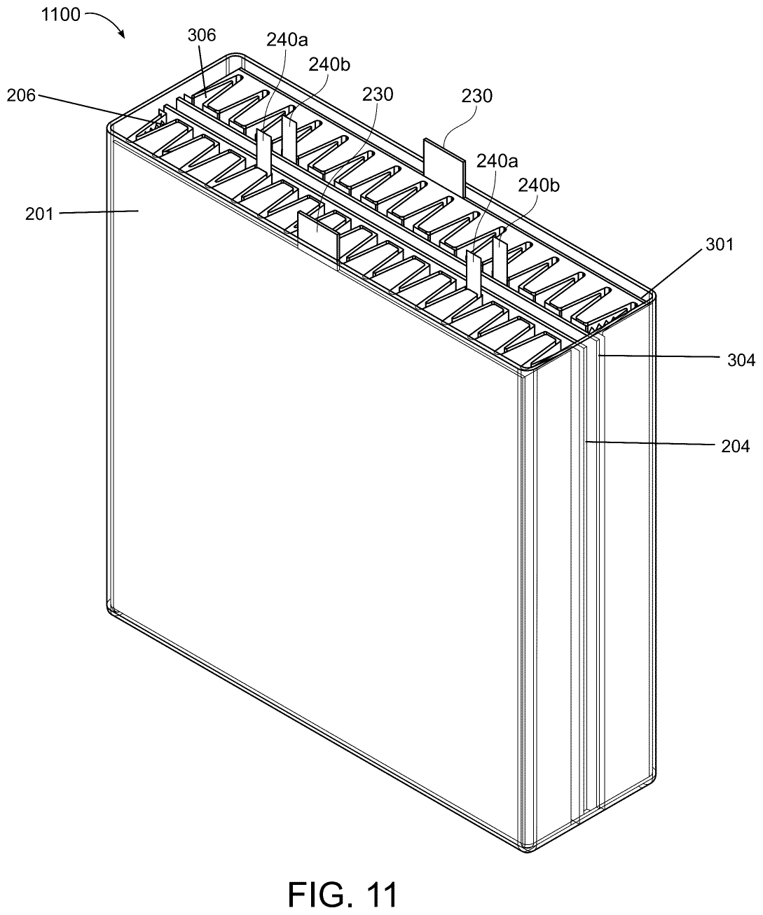

FIG. 11 is an isometric view 1100 of an iron-air battery of FIG. 10. In FIG. 11, the anode tabs 230 are shown connected to the respective current collectors 201, 301. In addition, cathode tabs 240a are shown connected to the first OER electrode 206, and cathode tabs 240b are shown connected to the second OER electrode 306.

In another aspect, provided is an iron-air battery including an iron electrode including a plurality of anodes separated by a plurality of channels, wherein the plurality of anodes are in electrical communication with each other; an ORR electrode having a first surface facing the plurality of channels and an opposing second surface in contact with air; an OER electrode interdigitated with the plurality of channels, wherein at least a portion of the OER electrode is disposed within the plurality of channels in a direction perpendicular to a plane of the ORR electrode; and an electrolyte in contact with the iron electrode, the first surface of the ORR electrode, the plurality of channels, and the OER electrode.

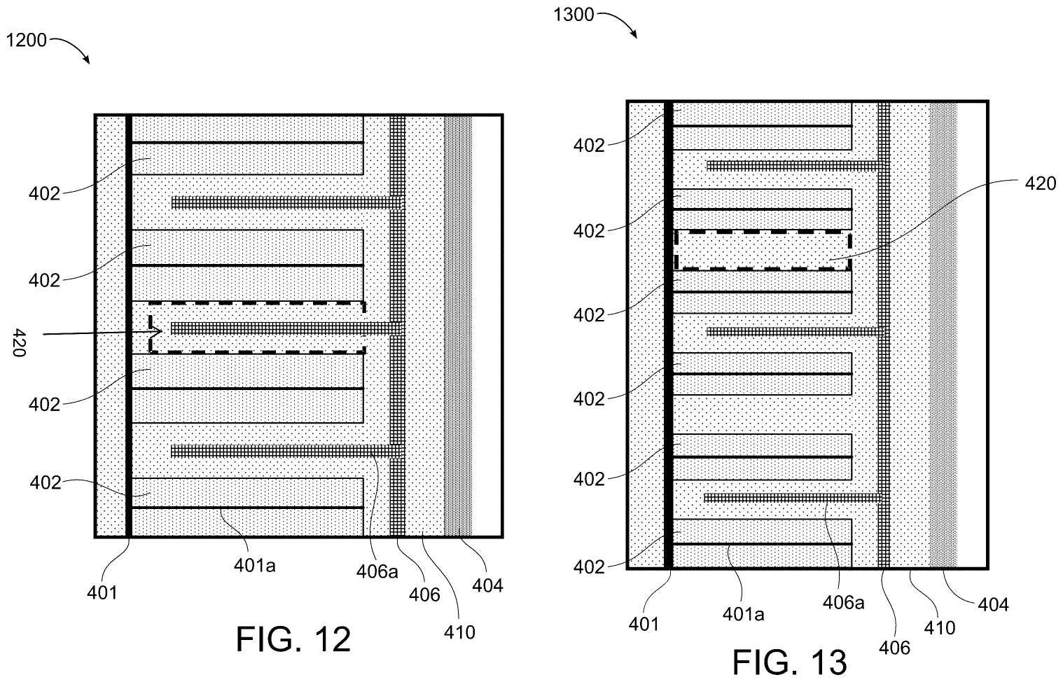

FIG. 12 shows one or more embodiments of an iron-air battery 1200. The iron-air battery 1200 includes an iron electrode including a plurality of anodes 402 separated by a plurality of channels 420, wherein the plurality of anodes 402 are in electrical communication with each other. For example, the plurality of anodes 402 may be connected via a bus bar or current collector 401. As shown in FIG. 12, a plurality of channels 420 are disposed between the plurality of anodes 402. The anodes 402 may have any suitable shape, and therefore the shape of the channels 420 will correspond to the shape of the adjacent anodes 402 that define the channel 420. Each anode 402 may have the same shape or a different shape, and hence each channel 420 may have the same shape or a different shape.

One or more anodes of the plurality of anodes 402 may have an average length that is 3 mm to 50 mm in a direction perpendicular to the plane of the ORR electrode 404. For example, one or more anodes of the plurality of anodes 402 may have an average length that is 15 mm to 35 mm, or 15 to 30 mm, or 15 to 25 mm in a direction perpendicular to the plane of the ORR electrode 404.

In the iron-air battery 1200, anodes of the plurality of anodes may have an average width that is 1 mm to 40 mm in a direction parallel to the plane of the ORR electrode 404. For example, anodes of the plurality of anodes 402 may have an average width that is 2 mm to 30 mm, or 2 to 20 mm, or 2 to 15 mm in a direction parallel to the plane of the ORR electrode 404.

In the iron-air battery 1200, anodes of the plurality of anodes 402 may be separated from each other by an average distance that is 10 mm to 50 mm in a direction parallel to the plane of the ORR electrode 404. For example, one or more anodes of the plurality of anodes 404 may be separated from each other by an average distance that is 10 mm to 30 mm, or 10 mm to 20 mm in a direction parallel to the plane of the ORR electrode 404, when measured between centers of adjacent anodes.

In FIG. 12, the iron-air battery 1200 may further include a current collector 401, wherein the plurality of anodes 402 is in contact with an anode current collector 401. In other embodiments, the anode current collector 401 may be replaced by a bus bar (not shown) that is connected to each anode of the plurality of anodes 402.

In FIG. 12, the iron-air battery 1200 includes an ORR electrode 404 having a first surface facing the plurality of channels 420 and an opposing second surface in contact with air. The ORR electrode 404 may be as defined herein.

In FIG. 12, the iron-air battery 1200 includes an OER electrode 406 that is interdigitated with the plurality of channels 420 of the iron electrode, wherein at least a portion of the OER electrode 406 is disposed within the plurality of channels 420 in a direction that is perpendicular to a plane of the ORR electrode 404. Hence, the OER electrode 406 has portions that are disposed in the channels 420 in a direction that is perpendicular to the first surface of the ORR electrode 404, such that the OER electrode 406 is interdigitated with the plurality of anodes 402.

In FIG. 12, the iron-air battery 1200 also includes an electrolyte 410 that is in contact with the plurality of anodes 402, the first surface of the ORR electrode 404, the plurality of channels 420, and the OER electrode 406. The electrolyte 410 is as described herein.

In some embodiments, the iron-air battery 1200 may also include a separator (not shown) that is disposed between at least a portion of the anodes 402 and the OER electrode 406. For example, the separator may be disposed in each of the channels 420 between the anodes 402 and the OER electrode 406. The separator materials may be as described herein.

As shown in FIG. 12, the OER electrode 406 may include a trunk portion that is disposed between the plurality of anodes 402 and the ORR electrode 404, and a plurality of cathode projections 406a that extend from the trunk portion and are disposed within the plurality of channels 420 between the plurality of anodes 402. The trunk portion of the OER electrode 406 is not interdigitated with the plurality of channels 420 between the plurality of anodes 402. For example, the trunk portion of the OER electrode 406 may be parallel to the ORR electrode 404. The cathode projections 406a may have any suitable shape, and may be, for example, rectangular (e.g., box-shaped), triangular (e.g., pyramidal), trapezoidal, ellipsoidal (e.g., cylindrical), or the like, in cross-section.

In some embodiments, the plurality of cathode projections 406a may have an average length that is 3 mm to 50 mm when measured from the trunk portion. For example, the plurality of cathode projections 406a may have an average length that is 5 mm to 35 mm, or 10 mm to 30 mm when measured from the trunk portion. In some embodiments, the plurality of cathode projections 406a may have a width that is 0.1 mm to 20 mm, or 0.5 mm to 15 mm, when measured in a direction parallel to the trunk portion.

The iron-air battery 1200 may include a current collector 401 that further includes one or more branch current collectors 401a disposed parallel to the plurality of channels 420, in a direction perpendicular to the ORR electrode 404. In this arrangement, a primary current collector 401 is connected to the one or more branch current collectors 401a, where the primary current collector is disposed parallel to the ORR electrode 404. In some embodiments, the branch current collectors 401a may be electrically connected to a bus bar, for example to a bus bar that is disposed above or below the plane of the plurality of anodes 402. In some embodiments, each anode of the plurality of anodes 402 is in contact with a branch current collector 401a, wherein each branch current collector 401a is connected a primary current collector 401 that is disposed parallel to the first surface of the ORR electrode 404. For example, each anode of the plurality of anodes 402 may be in contact with a branch current collector 401a, wherein the each branch current collector 401a is connected a primary current collector 401 that is disposed parallel to the first surface of the ORR electrode 404, wherein the primary current collector 401 is disposed outside a plane defining an active area of the plurality of anodes 402, the OER electrode 406, and the ORR electrode 404.

In some embodiments, greater than 25% of the channels of the plurality of channels 420 include the OER electrode 406 disposed therein. That is, some of the channels of the iron electrode may include the OER electrode, and some of the channels of the iron electrode may not include the OER electrode. As shown in FIG. 13, one or more channels 420 may be devoid of an OER electrode 406, where the OER electrode 406 is found in a portion of the channels 420 between the plurality of anodes 402. For example, greater than 40%, or greater than 50%, or greater than 60% of channels of the plurality of channels 420 may include the OER electrode 406, 406a disposed therein.

In some embodiments, one or more channels of the plurality of channels in FIG. 12 or 13 may further include an additive, as described herein. In some embodiments, a channel 420 may include an additive without including an OER electrode disposed therein. In other embodiments, a channel 420 may include both an additive and an OER electrode disposed therein.

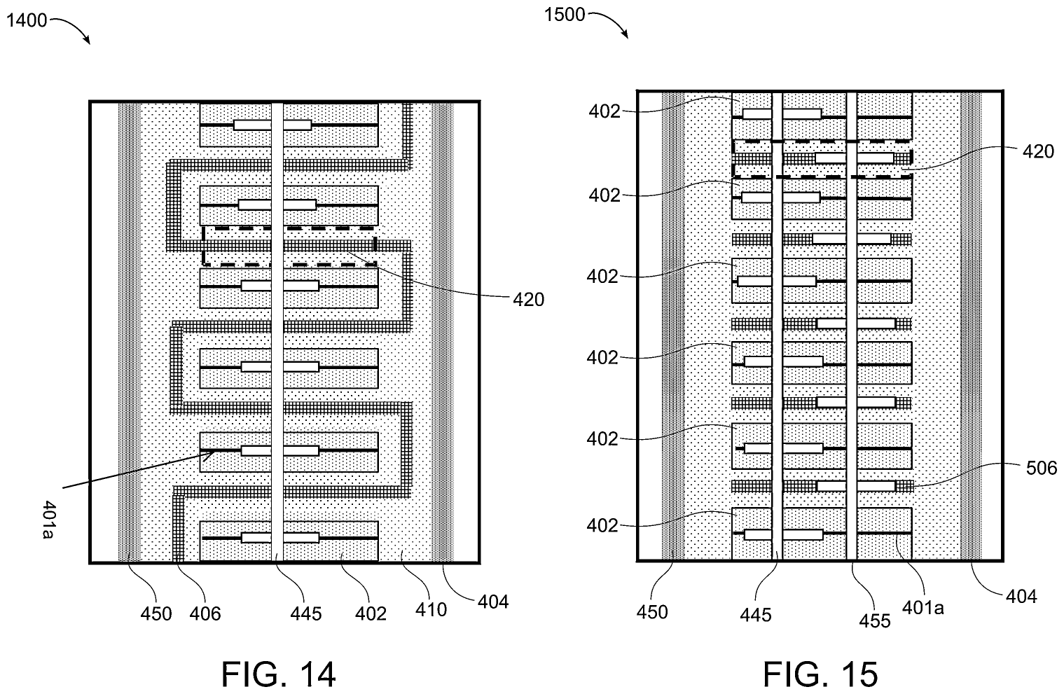

In some embodiments, an iron-air battery may have an OER electrode that is disposed in a serpentine manner between the plurality of anodes. Referring to FIG. 14, the iron-air battery 1400 includes an OER electrode 406 that is disposed in a serpentine configuration in the plurality of channels 420 between the plurality of anodes 402. When the OER electrode is disposed in a serpentine, it may be beneficial to further include a second ORR electrode. In some embodiments, the iron-air battery may further include a second ORR electrode 450 having a first surface facing the plurality of channels 420 and an opposing second surface in contact with air, wherein a plane of the second ORR electrode 450 is parallel to the plane of the ORR electrode 404.

The anodes 402 of the iron-air battery 1400 further include branch current collectors 401a that are disposed parallel to the plurality of channels 420, in a direction perpendicular to the ORR electrode 404. In this arrangement, the branch current collectors 401a are electrically connected to a bus bar 445, for example to a bus bar 445 that is disposed above (or below) the plane of the plurality of anodes 402. In some embodiments, each anode of the plurality of anodes 402 includes a branch current collector 401a, wherein each branch current collector 401a is connected a bus bar 445 that is disposed parallel to the first surface of the ORR electrode 404. For example, each anode of the plurality of anodes 402 may be in contact with a branch current collector 401a, wherein the each branch current collector 401a is connected a bus bar 445 that is disposed parallel to the first surface of the ORR electrode 404, wherein the bus bar 445 is disposed outside a plane defining an active area of the plurality of anodes 402, the OER electrode 406, and the ORR electrode 404.

Still another aspect provides an iron-air battery that includes an iron electrode including a plurality of anodes separated by a plurality of channels, wherein the plurality of anodes is in electrical communication with each other; an oxygen reduction reaction electrode having a first surface facing the plurality of channels and an opposing second surface in contact with air; an oxygen evolution reaction electrode including a plurality of cathodes interdigitated with the plurality of anodes, wherein the plurality of cathodes is disposed within the plurality of channels in a direction perpendicular to a plane of the oxygen reduction reaction electrode, and wherein the plurality of cathodes is in electrical communication with each other; and an electrolyte in contact with the iron electrode, the first surface of the oxygen reduction reaction electrode, the plurality of channels, and the oxygen evolution reaction electrode.

FIG. 15 shows one or more embodiments of an iron-air battery 1500. The iron-air battery 1500 includes an iron electrode including a plurality of anodes 402 separated by a plurality of channels 420, wherein the plurality of anodes 402 are in electrical communication with each other. For example, the plurality of anodes 402 may be connected via a bus bar 445. As shown in FIG. 15, a plurality of channels 420 are disposed between the plurality of anodes 402. The anodes 402 may have any suitable shape, and therefore the shape of the channels 420 will correspond to the shape of the adjacent anodes 402 that define the channel 420. Each anode 402 may have the same shape or a different shape, and hence each channel 420 may have the same shape or a different shape.

In the iron-air battery 1500, one or more anodes of the plurality of anodes 402 may have an average length that is 3 mm to 50 mm in a direction perpendicular to the plane of the ORR electrode 404. For example, one or more anodes of the plurality of anodes 402 may have an average length that is 3 mm to 35 mm, or 15 to 30 mm, or 15 to 25 mm in a direction perpendicular to the plane of the ORR electrode 404.

In the iron-air battery 1500, anodes of the plurality of anodes may have an average width that is 1 mm to 40 mm in a direction parallel to the plane of the ORR electrode 404. For example, anodes of the plurality of anodes 402 may have an average width that is 2 mm to 30 mm, or 2 to 20 mm, or 2 to 15 mm in a direction parallel to the plane of the ORR electrode 404.

In the iron-air battery 1500, anodes of the plurality of anodes 402 may be separated from each other by an average distance that is 10 mm to 50 mm in a direction parallel to the plane of the ORR electrode 404. For example, one or more anodes of the plurality of anodes 404 may be separated from each other by an average distance that is 10 mm to 30 mm, or 10 mm to 20 mm in a direction parallel to the plane of the ORR electrode 404, when measured between centers of adjacent anodes.

In FIG. 15, the iron-air battery 1500 includes an ORR electrode 404 having a first surface facing the plurality of channels 420 and an opposing second surface in contact with air. The ORR electrode 404 may be as defined herein.

In FIG. 15, the iron-air battery includes an OER electrode including a plurality of cathodes 506 that are interdigitated with the plurality of anodes 402. The plurality of cathodes 506 is disposed within the plurality of channels 420 in a direction perpendicular to a plane of the ORR electrode 404, and wherein the plurality of cathodes 506 is in electrical communication with each other. As noted herein, each cathode of the plurality of cathodes 506 may be electrically connected to each other by a bus bar 455. For example, the bus bar 455 may be disposed in a plane that is above or below a plane defined by the plurality of cathodes 506, the plurality of anodes 402, and the ORR electrode.

In some embodiments, the plurality of cathodes 506 may have an average length that is 3 mm to 50 mm when measured in a direction perpendicular to a plane of the ORR electrode 404. For example, the plurality of cathodes 506 may have an average length that is 5 mm to 35 mm, or 10 mm to 30 mm when measured in a direction perpendicular to a plane of the ORR electrode 404. In some embodiments, the plurality of cathodes 406 may have a width that is 0.1 mm to 20 mm, or 0.5 mm to 15 mm, when measured in a direction parallel to the ORR electrode 404.

In FIG. 15, the iron-air battery 1500 also includes an electrolyte 410 that is in contact with the plurality of anodes 402, the first surface of the ORR electrode 404, the plurality of channels 420, and the plurality of cathodes 506. The electrolyte 410 is as described herein.

In some embodiments, the iron-air battery 1500 may also include a separator (not shown) that is disposed between at least a portion of the plurality of anodes 402 and the plurality of cathodes 506. For example, the separator may be disposed in each of the channels 420 between the anodes 402 and the cathodes 506. The separator materials may be as described herein.

The iron-air battery 1500 may include one or more branch current collectors 401a disposed parallel to the plurality of channels 420, in a direction perpendicular to the ORR electrode 404. In this arrangement, a bus bar 445 may be connected to the one or more branch current collectors 401a, where the bus bar 445 is disposed parallel to the ORR electrode 404. In some embodiments, the branch current collectors 401a may be electrically connected to a bus bar, for example to a bus bar that is disposed above or below the plane of the plurality of anodes 402, for example wherein the bus bar 445 is disposed outside a plane defining an active area of the plurality of anodes 402, the plurality of cathodes 506, and the ORR electrode 404.

In some embodiments, in the iron-air battery 1500, each cathode of the plurality of cathodes 506 may be in contact with a cathode current collector (e.g., bus bar), wherein the cathode current collector may be disposed outside a plane defining an active area of the plurality of anodes 402, the plurality of cathodes 506, and the ORR electrode 404. The iron-air battery may include first bus bars or wiring and second bus bars or wiring, where the first bus bar may be electrically connected to conductive tabs of the current collector branches, and the second bus bar may be electrically connected to conductive tabs of the branch electrodes. The first and second bus bars may be disposed above the iron electrode and/or the electrolyte.

In some embodiments, in FIG. 15, greater than 25% of the channels of the plurality of channels 420 include a cathode of the plurality of cathodes 506 disposed therein. That is, some of the channels 420 between the plurality of anodes 402 may include a cathode of the plurality of cathodes 506, and some of the channels 420 between anodes of the plurality of anodes 4-2 may not include the OER electrode (the cathode). For example, greater than 40%, or greater than 50%, or greater than 60% of the channels of the plurality of channels 420 may include a cathode of the plurality of cathodes 506 disposed therein.

In some embodiments, one or more channels of the plurality of channels in FIG. 15 may further include an additive, as described herein. In some embodiments, a channel 420 may include an additive without including a cathode of the plurality of cathodes 506 disposed therein. In other embodiments, a channel 420 may include both an additive and a cathode of the plurality of cathodes 506 disposed therein.

In some embodiments, the iron-air battery 1500 may further include a second ORR electrode 450 having a first surface facing the plurality of channels 420 and an opposing second surface in contact with air, wherein a plane of the second ORR electrode 450 is parallel to the plane of the (first) ORR electrode 404. The first and second ORR electrodes 404, 450 may be disposed on opposing sides of, and equidistant from, the iron electrode (anodes 402). This dual ORR electrode design may improve discharge uniformity. For example, this design may normalize the conversion of iron oxides and/or hydroxides within different portions of the plurality of anodes 402.

In some embodiments, a plurality of electrochemical cells may be arranged so that a central channel between cells may be in contact with air. For example, the iron-air battery of FIG. 15 may be duplicated across an air channel that flows between cells.

Another aspect provides an iron-air battery that includes an iron electrode in contact with an anode current collector, wherein the iron electrode includes a plurality of channels as described herein. The iron-air battery includes an ORR electrode having a first surface facing the plurality of channels and an opposing second surface in contact with air, and an OER electrode comprising a plurality of cathodes interdigitated with the iron electrode. The plurality of cathodes is disposed within the plurality of channels in a direction perpendicular to a plane of the OER electrode, and wherein the plurality of cathodes is in electrical communication with each other. The iron-air battery includes an electrolyte in contact with the iron electrode, the first surface of the oxygen reduction reaction electrode, the plurality of channels, and the oxygen evolution reaction electrode. Like the embodiments of FIG. 2, the iron electrode is monolithic having channel portions, whereas the OER electrode is arranged as a series of cathodes interdigitated within the channels as described in embodiments for FIG. 15.

The iron-air battery can include a separator disposed between at least a portion of the iron electrode and the plurality of cathodes. The separator may be as described herein.

Another aspect provides an iron-air battery including an iron electrode in contact with an anode current collector, wherein the iron electrode and the anode current collector are arranged in a spiral configuration; an oxygen reduction reaction electrode having a first surface facing an axis of rotation of the spiral configuration and an opposing second surface in contact with air; an oxygen evolution reaction electrode arranged in a spiral configuration and interdigitated with the iron electrode, wherein the iron electrode and the oxygen evolution reaction electrode are at least partially bifilar; and an electrolyte in contact with the iron electrode, the first surface of the oxygen reduction reaction electrode, and the oxygen evolution reaction electrode.

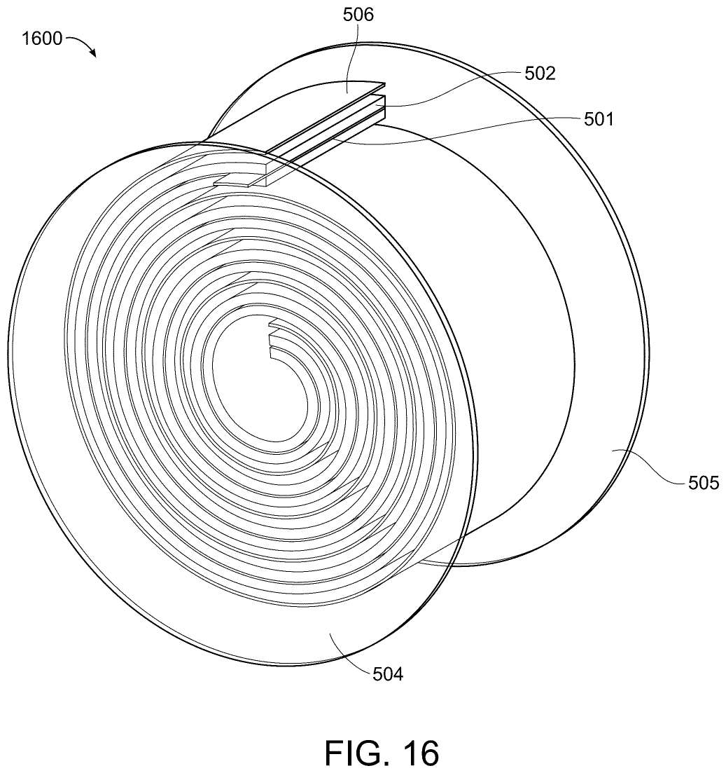

FIG. 16 shows one or more embodiments of an iron-air battery 1600 having a spiral configuration. The iron-air battery 1600 includes an iron electrode 502 that is in contact with an anode current collector 501, wherein the iron electrode 502 and the anode current collector 501 are arranged in a spiral configuration. The iron-air battery 1600 further includes an ORR electrode 504 having a first surface facing an axis of rotation of the spiral configuration and an opposing second surface in contact with air. In the iron-air battery 1600, an OER electrode 506 is arranged in a spiral configuration and interdigitated with the iron electrode 502, wherein the iron electrode 502 and the OER electrode 506 are at least partially bifilar.

In FIG. 16, the iron-air battery 1600 also includes an electrolyte (not shown) that is in contact with the iron electrode 502, the first surface of the ORR electrode 504, and the OER electrode 506. The electrolyte is as described herein.

In some embodiments, the iron-air battery 1600 may also include a separator (not shown) that is disposed between at least a portion of the iron electrode 502 and the OER electrode 506. For example, the separator may be disposed between the bifilar portions of the iron electrode 502 and the OER electrode 506. The separator materials may be as described herein.

In some embodiments, as shown in FIG. 16, the iron-air battery 1600 may further include a second ORR electrode 505 having a first surface facing an axis of rotation of the spiral configuration and an opposing second surface in contact with air, wherein a plane of the second ORR electrode 505 is parallel to the plane of the (first) ORR electrode 504.

According to another aspect, provided is an iron-air battery including an iron electrode in contact with an anode current collector, wherein the iron electrode and the anode current collector are arranged in a pleated configuration, and wherein the iron electrode includes a plurality of channels between the pleats; an oxygen reduction reaction electrode having a first surface facing the plurality of channels and an opposing second surface in contact with air; an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode, and wherein the oxygen evolution reaction electrode is arranged in a pleated configuration; and an electrolyte in contact with the iron electrode, the first surface of the oxygen reduction reaction electrode, the plurality of channels, and the oxygen evolution reaction electrode.

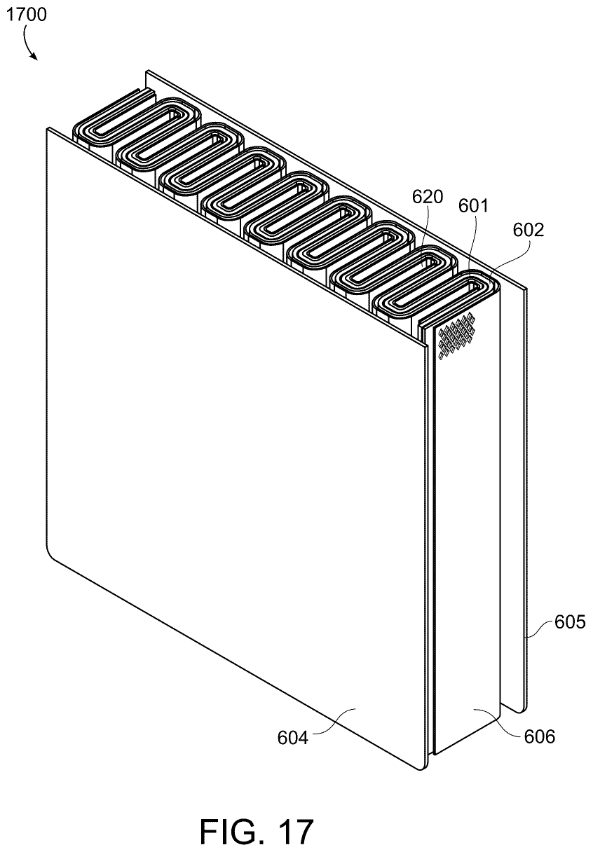

FIG. 17 shows one or more embodiments of an iron-air battery 1700 having a pleated configuration. The iron-air battery 1700 includes an iron electrode 602 that is in contact with a current collector 601, wherein the iron electrode 602 and the anode current collector 601 are arranged in a pleated configuration, as shown in FIG. 17. The pleated configuration provides a plurality of channels 620 that are disposed between the pleats or folds/turns of the electrode assembly.

The iron-air battery 1700 further includes an ORR electrode 604 having a first surface facing the plurality of channels 620 and an opposing second surface in contact with air. In some embodiments, the iron-air battery 1700 may further include a second ORR electrode 605 having a first surface facing the plurality of channels 620 and an opposing second surface in contact with air.

The iron-air battery 1700 includes an OER electrode 606 that is interdigitated with the plurality of channels 620 of the iron electrode 602, wherein at least a portion of the OER electrode 606 is disposed within the plurality of channels 620 in a direction perpendicular to a plane of the ORR electrode 604, and wherein the OER electrode 606 is arranged in a pleated configuration. In other words, the iron electrode 602, the current collector 601, and the OER electrode 606 are all arranged in a pleated configuration, such that the OER electrode 606 is disposed, via the pleats, in the plurality of channels 620 of the iron electrode 602.

In FIG. 17, the iron-air battery 1700 also includes an electrolyte (not shown) that is in contact with the iron electrode 602, the first surface of the ORR electrode 604, and the OER electrode 606. The electrolyte is as described herein.

In some embodiments, the iron-air battery 1700 may also include a separator (not shown) that is disposed between at least a portion of the iron electrode 602 and the OER electrode 606, wherein the separator is arranged in a pleated configuration. For example, the separator may be disposed between the pleated portions of the iron electrode 602 and the OER electrode 606. The separator materials may be as described herein.

In some embodiments, as shown in FIG. 17, the iron-air battery 1700 may further include a second ORR electrode 605 having a first surface facing the plurality of channels and an opposing second surface in contact with air, wherein a plane of the second ORR 605 electrode is parallel to the plane of the (first) ORR electrode 604.

In some embodiments, in FIG. 17, the OER electrode 606 is arranged on a first surface of the iron electrode 602, and the iron-air battery 1700 further includes a second OER electrode (not shown) that is interdigitated with the plurality of channels of the iron electrode 602. The second OER electrode may be arranged at a second opposing surface of the iron electrode 602, wherein at least a portion of the second OER electrode is disposed within the plurality of channels 620 in a direction perpendicular to a plane of the ORR electrode 604, and wherein the second OER electrode is arranged in a pleated configuration. In some embodiments, the iron electrode may be sandwiched between a first OER electrode and a second OER electrode, wherein the iron electrode, the first OER electrode, and the second OER electrode are arranged in a pleated configuration.

The components of the iron-air batteries that are described in FIGS. 2 to 17 are interchangeable and will be described herein below.

In some embodiments, the electrolyte includes a solid oxide electrolyte, a solid polymer electrolyte, a molten salt, an aqueous solution, a non-aqueous solution, a gel, or a combination thereof. For example, the electrolyte may include an aqueous solution of an alkali hydroxide, an organic hydroxide, or a combination thereof.

The electrolyte may be an aqueous solution. In some embodiments the electrolyte may be an alkaline solution (pH>10), a near-neutral solution (10>pH>4), or an acidic solution (4>pH>0). In some embodiments, the electrolyte may be an alkaline solution having a high hydroxide concentration, such as hydroxide concentrations at or above 5 moles per liter (M) (e.g., 5 M to 6 M, 6 M or greater, 6 M to 7 M, 7 M or greater, 7 M to 11 M, 7 M to 10 M, 7.5 M to 9.5 M, greater than 7.5 M to less than 9.5 M, or the like). In some embodiments, the solvent in the electrolyte may be water, and preferably high purity water, such as de-ionized water.

In various embodiments, the electrolyte may include any one or more of KOH, NaOH, LiOH, RbOH, CsOH, FrOH, Be(OH)₂, Ca(OH)₂, Mg(OH)₂, Sr(OH)₂, Ra(OH)₂, Ba(OH)₂, or a combination thereof. In some embodiments, KOH, NaOH, and/or LiOH may be combined in ratios whereby [KOH]>[NaOH]>[LiOH]. For example, some embodiments may include around 4M KOH, 2M NaOH, 0.05M LiOH, or other combinations thereof. In various embodiments, KOH, NaOH, and LiOH are combined in ratios whereby [NaOH]>[KOH]>[LiOH]. Still other embodiments may include 4M NaOH, 2M KOH, 0.05M LiOH, or other combinations thereof.

Various embodiments include using a high hydroxide concentration electrolyte, such as a 7 M hydroxide concentration or greater. In various embodiments, a high hydroxide concentration electrolyte, such as a 7 M hydroxide concentration or greater, may increase the amount of charge stored in the cell (i.e., the capacity of the battery material), improve the coulombic efficiency (i.e., increase the fraction of electrons stored in the intended charge product(s) as opposed to being lost in a side reaction), and/or decrease the overpotential (i.e., increase the voltage) of the iron-air battery.

The OER electrode may be permeable to the electrolyte. For example, the OER electrode may be formed from a porous metal sheet or mesh. In some embodiments, the OER electrode may preferably be formed of a nickel mesh or a nickel-plated steel mesh. The OER electrode may include an oxygen evolution catalyst. For example, in some embodiments, the OER electrode may include a porous metal mesh and an oxygen evolution catalyst.

Exemplary oxygen evolution catalysts may include nickel, alloys of nickel with iron, manganese oxide, iron, nickel oxide (NiOₓ), nickel oxyhydroxide (NiOₓ(OH)_{y}), iron oxide, (FeOₓ), iron oxyhydroxide (FeOₓ(OH)_{y}), or the like. The OER electrode is disposed closer to the iron electrode than the ORR electrode to facilitate charging. The OER may be electrically insulated from the iron electrode and the ORR electrode.

The ORR electrode is electrically conductive and permeable to oxygen. The ORR electrode may include a conductive gas diffusion electrode (GDE) catalyst, such as carbon, manganese oxide, silver, platinum, nickel foam, a nickel mesh, or the like, and may also include a hydrophobic material, such as polytetrafluoroethylene (PTFE), for example. For example, the ORR electrode may include a hydrophilic region and a hydrophobic region. The hydrophobic region may be exposed to air and the hydrophilic region may be exposed to the electrolyte. In other words, the hydrophilic region that is exposed to the electrolyte is the side that is facing the plurality of channels of the iron electrode.

The coulombic efficiency of an iron electrode during charging may be affected by the configuration of the OER electrode. For example, the coulombic efficiency can be improved by reducing the distance between the back of the iron electrode and the OER electrode, thereby reducing the distance through which ions must travel through the porous iron electrode to reach iron hydroxide.

The iron electrode may be a solid, including a dense or porous solid, or a mesh or foam, or a particle or collection of particles, or may be a slurry, ink, suspension, or paste. For example, the iron electrode may be a bulk solid. As another example, iron electrode may be a collection of particles, such as small or bulky particles, within a suspension that are not buoyant enough to escape the suspension into the electrolyte. As another example, the iron electrode may be formed from particles that are not buoyant in the electrolyte.

In some embodiments, the iron electrode may be formed of a porous iron-containing material. For example, the iron electrode may include metallic iron and various iron compounds, such as iron oxides, hydroxides, sulfides, carbides, or combinations thereof. In some embodiments, the iron electrode may be formed from pelletized, briquetted, pressed, powdered, and/or sintered iron-containing compounds. The iron-containing compounds may include one or more forms of iron, ranging from highly reduced (more metallic) iron to highly oxidized iron (having a higher average valence). In some embodiments, the iron electrode may be sintered iron agglomerates having various shapes.

In some embodiments, atomized or sponge iron powders can be used as the feedstock material for forming sintered iron electrodes. For example, the iron electrode may include metallurgically-bonded sponge iron particles, such as direct reduced iron (DRI) or other sponge iron powder particles, wherein the microporosity with the sponge iron particles is >50 vol % and the particle size of the sponge iron particles is >100 microns.

In some embodiments, the iron electrode may have a surface density of 1 gram of iron per square centimeter (cm²) to 7 grams of iron/cm², relative to a direction perpendicular to the oxygen reduction reaction electrode. For example, the iron electrode may have a surface density of 2 grams of iron/cm²/to 5 grams of iron/cm², relative to a direction perpendicular to the oxygen reduction reaction electrode. Herein, the average electrode loading may refer to the mass of iron active material per apparent area, where apparent area is the area of the plane of the ORR electrode. The iron active material may be distinguished from current collector in that the iron active material is microporous.

The iron electrode (or plurality of anodes comprising the iron electrode) includes a plurality of channels. The channels may be oriented vertically, to allow generated bubbles, such as bubbles of hydrogen, to move vertically and exit the iron electrode and/or the electrolyte. In other words, a long axis of each channel may extend in a vertical direction. In some embodiments, the channels may have rectangular cross-sections, such that sidewalls of the channels may be disposed in planes that are perpendicular or substantially perpendicular to a plane of the ORR electrode. While illustrated as uniform channels in the figures, the channels may not all be the same. Some channels may contain the OER electrode as discussed below. Other channels may be used to provide space for supporting materials, such as structurally reinforcing material and/or sparingly soluble additives, and may not contain the OER electrode, as described herein.

The plurality of channels may be coated with a material that facilitates the removal of the bubbles from the iron electrode. The channels may further include a structural material that is configured to maintain electrical contact throughout the iron electrode. In some embodiments, the channel width may be less than the width of the protrusions (or features) that define the iron electrode. In some embodiments, due to the plurality of channels, the iron electrode may have a channel fraction of from about 0.1 and to about 0.5, such as from about 0.2 to about 0.45, where channel fraction is defined as CW/(CW+RW), where CW is channel width and RW is rib width (rib width is the width of the iron electrode feature defining the channel).

The plurality of channels includes the electrolyte. In some embodiments, a volume fraction of the electrolyte in the iron electrode is 0.5 to 0.9, based on the total volume of the iron electrode when fully charged. The electrolyte volume fraction may be defined as (volume of electrolyte)/(volume of electrode) and may be measured by mercury porosimetry, for example.

The current collector may be in the form of a metal plate, such as an iron, nickel, stainless steel, nickel-plated stainless steel plate, or the like. The current collector may be porous or nonporous. In some embodiments, the current collector may be a mesh or perforated sheet having void dimensions (e.g., through holes) ranging from about 0.1 mm to about 10 mm, to facilitate electrolyte flow therethrough.

The current collector may be configured to electrically connect the plurality of anodes that comprise the iron anode. In some embodiments, the plurality of anodes may be welded to the current collector. In other embodiments, the plurality of anodes may optionally be electrically connected by tabs extending from the plurality of anodes and formed of iron, steel, or nickel-plated steel. The iron-air battery may also include a bus bar, wiring, or the like to electrically connect a plurality of current collectors to a common electrical terminal.

The current collector may include branches that extend from the current collector onto or into each of the rib portions of the iron electrode, or the iron electrode may be a plurality of anodes that each includes a branch current collector disposed therein. For example, the branch current collectors may be highly conductive wires or sheets (e.g., stainless steel) that extend inside of the rib portions or the plurality of anodes. In the alternative, the branch current collectors may be in the form of a mesh or cage that surrounds and/or compresses each rib portion or each anode of the plurality of anodes.

The OER electrode may be a planar mesh, such as a nickel mesh, or a nickel-plated stainless steel mesh, having a thickness of less than about 1.5 mm or less than about 1.0 mm. In some embodiments, the OER electrode may have a thickness from about 1 mm to about 0.1 mm, such as from about 0.5 mm to about 0.1 mm. The OER electrode may include a catalyst configured to catalyze the oxidation of alkaline electrolyte materials to generate oxygen gas. When the OER electrode does not form a physical barrier between the iron electrode and the ORR electrode, the OER electrode may be formed of a solid, non-mesh material. Any suitable material may be used.

The OER electrode may include a plurality of cathode projections that extend from a trunk portion and into each of the plurality of channels. Accordingly, the cathode projections (or plurality of cathodes) may be interdigitated with the plurality of channels (or with the plurality of anodes). The trunk portion of the OER electrode may electrically connect the cathode projections to a charge terminal, such that each cathode projection (or cathode) receives substantially the same electrical potential during charging.

The channels may be coated with an inert, electrically insulating material that functions to prevent electrical shorting of the iron electrode and the OER electrode. The channels may include a material that functions to guide bubbles vertically out of the cell. The channels may further include structural material that serves to maintain electrical contact across the iron electrode.

In some embodiments, one or more additives, which include lead, tin, antimony, copper, silver, gold, or the like, may be added to one or more channels of the iron electrode. The addition of one or more additives in accordance with various embodiments may improve charging of an iron-containing negative electrode (iron electrode). In some embodiments, the one or more additives may include elements that in their metallic form have a low rate of hydrogen evolution reaction (HER). In some embodiments, the one or more additives may include an electrolyte that includes one or more hydroxides. In some embodiments, the one or more additives may include an electrolyte that does not include hydroxides.

In various embodiments, additives that suppress hydrogen evolution, such as metals with low hydrogen evolution reaction (HER) activity (such as lead (Pb), tin (Sn), antimony (Sb), etc.) may be added to an electrochemical cell to thereby improve charging of the iron-based negative electrode (iron anode). In various embodiments, additives that suppress hydrogen evolution, such as metals with low hydrogen evolution reaction (HER) activity (such as lead (Pb), tin (Sn), antimony (Sb), etc.) may be added to the electrolyte and/or anode of the electrochemical cell.

In some embodiments, additives that suppress hydrogen evolution, such as metals with low hydrogen evolution reaction (HER) activity (such as lead (Pb), tin (Sn), antimony (Sb), or the like) may be added to improve charging of the iron anode. In some embodiments, additives that suppress hydrogen evolution, such as metals with low hydrogen evolution reaction (HER) activity (such as lead (Pb), tin (Sn), antimony (Sb), etc.) may be added to the electrolyte and/or channels of the iron-air battery.

In some embodiments, additives that improve the conductive network in the iron electrode, such as highly conductive metals (tin (Sn), copper (Cu), silver (Ag), gold (Au)) or derivatives thereof may be added to improve charging of the iron-containing negative electrode. In some embodiments, additives that improve the conductive network in the iron electrode, such as highly conductive metals (tin (Sn), copper (Cu), silver (Ag), gold (Au)) or derivatives thereof, may be added to the electrolyte and/or the iron electrode. A highly conductive metal may be a metal element that has an electrical resistivity below 125 nano-ohm-meters (nΩ·m).

In some embodiments, a sulfide may be included as an additive in the electrolyte. For example, the electrolyte may have a sulfide concentration between 0.0001 M and 0.5 M, typically as sodium sulfide. Other salts may be used to add sulfide to the electrolyte, such as bismuth sulfide, copper sulfide, iron sulfide, manganese sulfide, potassium sulfide, zinc sulfide, or the like, or a combination thereof. In some embodiments, no sulfide additive may be added to the electrolyte. In some embodiments, sulfide may be present in other aspects of the electrochemical cell, such as in the form of additives to the iron electrode. As an example, sulfide or a sulfide-containing compound may be an additive to the iron electrode when the electrolyte composition at the time of cell assembly has no sulfide therein. In some embodiments, other electrolyte additives known in the art to enhance performance of iron electrodes may also be used in the electrolyte.

The separator may be a passive separator, such as conventional diaphragm separators, or may be an active separator, such as ion exchange membranes. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In some embodiments, the separator may be formed of a dielectric material, or a porous material, which is permeable to positive ions, such as Fe²⁺, Fe³⁺, K⁺, Na⁺, Cs⁺, and/or NH₄⁺ ions, or the like, or a combination thereof, or negative ions, such as hydroxide ions, or the like. The separator may be impermeable or effectively impermeable to active materials of the catholyte and anolyte. In some embodiments, the separator may be a membrane, such as a membrane formed from a polymer with a tetrafluoroethylene backbone and side chains of perfluorovinyl ether groups terminated with sulfonate groups (e.g., a sulfonated tetrafluoroethylene membrane, a membrane made of polymers sold under the Nafion brand name, etc.), or the like.

In some embodiments, the separator may include an anion exchange membrane (AEM), a cation exchange membrane (CEM), a zwitterionic membrane, a porous membrane having an average pore diameter of less than 10 nanometers, a polybenzimidazole-containing membrane, a polysulfone-containing membrane, polycarboxylic-containing membrane, a polyetherketone-containing membrane, a membrane including polymer(s) of intrinsic microporosity (PIM), or the like, or a combination thereof. Preferably, the separator includes an anion exchange membrane (AEM) or a cation exchange membrane (CEM). In some embodiments, the separator may include a composite membrane including an inorganic material and an organic material. In some embodiments, the inorganic material may include a metal oxide or a ceramic material. In some embodiments, the organic material may include a polyether ether ketone (PEEK), a polysulfone, a polystyrene, a polypropylene, a polyethylene, or the like, or a combination thereof.

In some embodiments, a separator may be used that provides a physical barrier between the iron electrode and the OER electrode. For example, the separator may include a porous polyolefin film, a glass fiber mat, a cotton fabric, a rayon fabric, cellulose acetate, paper, or the like, or a combination thereof. In some embodiments, the separator may be a dielectric structure or frame, a ribbed structure, or a porous insulator. In some embodiments, the separator may include a porous frame configured to compress the iron electrode.

In some embodiments, multiple iron-air batteries (or electrochemical cells) may be connected electrically in series to form a stack. In other embodiments, a plurality of iron-air batteries (or electrochemical cells) may be connected electrically in parallel. In certain other embodiments, the iron-air batteries (or electrochemical cells) are connected in a combination of series and parallel electrical connections.

Also provided are methods of preparing the iron-air battery as described herein. The method includes forming an iron negative electrode material onto an anode current collector to form the iron electrode including a plurality of channels; disposing the oxygen evolution reaction electrode into one or more channels of the iron electrode; and assembling the oxygen reduction reaction electrode having the first surface facing the iron electrode and the opposing second surface in contact with air to form an electrode assembly.

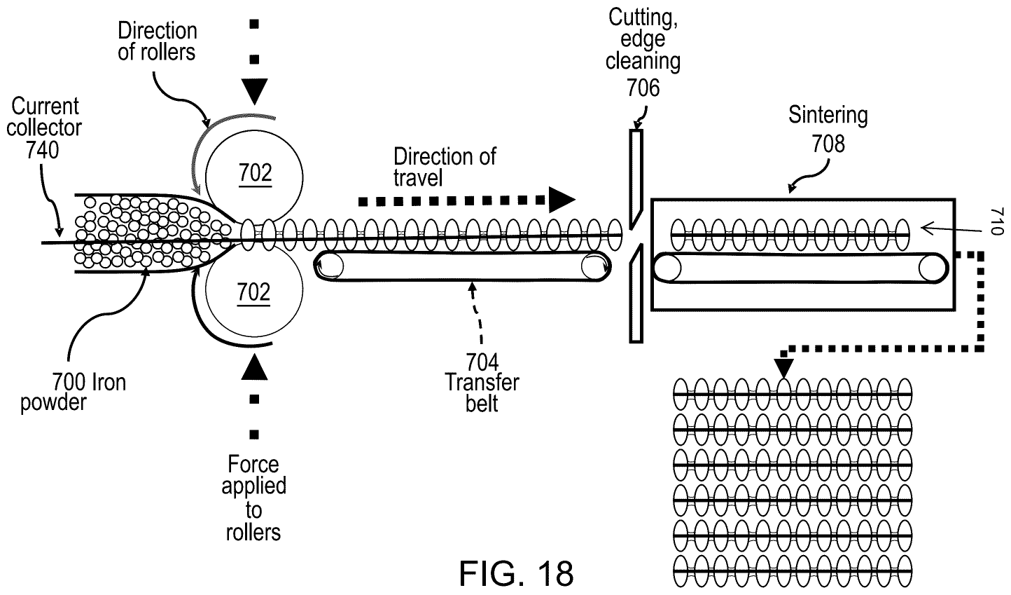

As shown in FIG. 18, an iron negative electrode material (e.g., iron powder 700) may be applied to a current collector 740 and then compressed to form the iron electrode, wherein the compressing (or forming step) provides a plurality of channels in the iron electrode. For example, an anode powder, such as an iron-containing electrode powder 700, may be disposed on opposing sides of a current collector 740 and fed to a pair of compression rollers 702. The compression rollers 702 may be configured to compress and form channels in the iron powder, thereby forming ribs in the iron anode along the current collector. The compression rollers 702 may be metal rollers having a channel pattern. The compression may occur at room temperature or at an elevated temperature.

In some embodiments, iron powder may be poured into a mold that has a channeled configuration. The iron powder may be compacted within the mold. In some embodiments, the iron powder may be pressed at room temperature, then heated. In some embodiments, the iron powder may be pressed at elevated temperature. In some embodiments, the iron powder may be compacted in a roll-based continuous process. In some embodiments, the iron powder may be combined with processing aids and may be extruded in a continuous process. In some embodiments, the iron powder may be manufactured as a solid plane and then channels are machined therein.

In some embodiments, the iron powder may be compacted into planar strips or other shapes (e.g., pyramidal, ellipsoidal, cylindrical, or the like). The strips may then be welded to a spine, which is connected to a current collector. Alternatively, the strips may be connected directly to the current collector, with no spine. Alternatively, each strip may be encased in a perforated/mesh steel cage. The cage provides both current collection and compression. The cage may be crimped, welded, bolted, or the like, or a combination thereof.

The product output from the compression rollers 702 may be taken up by a transfer belt 704 and provided to a cutting device 706. The cutting device 706 may separate the product into individual iron electrodes 710. In some embodiments, the cutting device 706 may be configured to polish cut edges of the iron electrodes 710.

The as-formed iron electrode 710 including the plurality of channels may be further sintered before or after the electrode is cut to proper length, etc. The iron electrodes 710 may optionally be provided to a furnace 708 and sintered. The optionally sintered iron electrodes 710 may be stacked and/or utilized to construct an iron-air battery. In the alternative, multiple iron electrodes 710 may be stacked and sintered together as a group.

In some embodiments, two iron electrodes can be fabricated back-to-back, on opposing sides of a current collector, such that they interlock on the channeled side and can still be pressed between parallel flat plates and achieve uniform strain by deforming together during compaction.

In other embodiments, iron electrode strips may be formed by compressing an iron electrode powder, and the compressed strips may be welded to a spine or current collector. In other embodiments, iron electrode powder may be manufactured as a sheet, and channels may be machined therein. In the alternative, a sacrificial channel-former material may be used to displace iron during assembly or compaction, then later removed through dissolving, pyrolysis, or the like, leaving behind the desired shape of channels in the fabricated iron electrode. In other embodiments, iron electrodes may be formed by additive manufacturing e.g., laser sintering or plasma spraying of powdered active material to build up the desired electrode geometry. Two iron electrodes may be fabricated back-to-back such that they interlock on the channeled side and can still be pressed between parallel flat plates and achieve uniform strain by deforming together during compaction.

In some embodiments, a sacrificial channel-former material may be used to displace iron during assembly or compaction, then later removed through dissolving, burnout, etc., leaving behind the desired shape of channels in the fabricated iron electrode.

In some embodiments, the iron electrode may be fabricated such that the porosity is approximately the same volume fraction and pore size in the spine portion as in the rib portions (i.e., powder microstructure is uniform throughout the solids-filled portion of the iron electrode). A channeled iron electrode with the same porosity in rib and spine may be achieved by sintering of packed powders, metal injection molding, or any suitable methods common in the art for assembling a mass of powder material and thermally or mechanically bonding it together uniformly. In some instances, a gelled powder mass may be coated into the shape, dried, and then processed. In some embodiments the bonding of the powder may take place through electrochemical sintering, rather than through mechanically-driven and/or thermally-driven consolidation.

In some embodiments, the iron electrode may have nonuniform porosity. The spine portion may play a unique structural role in the anode assembly. The bonding of the material in the spine portion to the current collector may facilitate anode adhesion to its current collector. Additionally, the spine portion is thinner than the rib portions, and so there is not as large a need to obtain high ionic transport in the spine portion relative to the rest of the iron electrode. Without wishing to be bound to theory, higher degrees of compaction and/or lower porosity may be desirable in the spine portion relative to the rib portions. The porosity/compaction gradients could be continuous, or close to a discrete, step-function-like gradient. The gradient in porosity can be determined by the manufacturing methods employed. For example, roll-compaction of a briquette-like structure produces a low-density rib structure and a higher-density spine structure.

In some embodiments, serpentine OER electrodes, as shown in FIG. 14, or corrugated OER electrodes, as shown in FIGS. 4, 5, 7, and 10, may be formed by bending, stamping, roll forming, and/or pleating a sheet of metal mesh to match the dimensions of a corresponding iron electrode. In the alternative, branch electrode portions may be welded to a planar trunk portion of an OER electrode to form interdigitated OER electrodes. As examples, the metal mesh of the OER electrodes may include a woven mesh, an expanded metal, a metal foam, or the like, or a combination thereof. In some embodiments, alternative fabrication of OER electrode may include the OER not being a continuous body. For example, the OER electrode may be prepared by welding “branches” (which fit into the anode channels) to a backing trunk portion, as described herein. In various embodiments, the OER electrode may have catalyst that is applied before or after the OER electrode shape is formed.

An oxygen evolution catalyst may be applied to the OER electrodes, before or after shaping/welding. A porous dielectric material may be coated/sprayed on the OER electrodes to form a separator. In the alternative, a porous dielectric separator sheet may be disposed between iron electrodes and corresponding OER electrodes.

The iron electrode and the OER electrode may be assembled, such that portions of the OER electrode are disposed within the channels. The ORR electrode may be assembled adjacent to the OER electrode to form an electrode assembly. The electrode assembly may be immersed in an electrolyte, such that the iron electrode, OER electrode, and one side of the ORR electrode are in contact with the electrolyte.

The method further includes assembling the ORR electrode having the first surface facing the iron electrode and the opposing second surface in contact with air to form an electrode assembly.

The method may further include adding an electrolyte to the completed electrode assembly. Alternatively, when the electrolyte is not a liquid, a solid or gel electrolyte may be added to the iron-air battery at any suitable step of the fabrication process.

In some embodiments, a separator and/or standoff may be designed to facilitate bubble egress and prevent electrical shorting between the iron electrode and the OER cathode. The separator and/or standoff may be placed on a planar OER electrode, and then the separator and/or standoff and the OER electrode may be bent or corrugated into the desired shape. Alternatively, the separator and/or standoff may be applied to the OER electrode after the OER electrode is bent/corrugated into shape. In some embodiments, a separator and/or standoff may be applied (placed, molded, sprayed, or the like) onto an iron electrode to form a separator-anode assembly. The distance between the iron electrode and the OER electrode may be configured to be large enough to enable bubbles to egress, prevent electrical shorting, and contain the electrolyte, without excessively increasing ionic resistance. For example, in various embodiments, the distance between the iron electrode and the OER electrode may be from 0.1 mm to 5 mm, such as from 1 mm to 4 mm, but embodiments are not limited thereto.

To prepare samples in the charged state for performing mercury porosimetry, the iron electrode may be brought to the fully charge state by charging the cell (i.e., the cell including the iron electrode and OER electrode) at a current greater than 6 mA/g to at least twice the cell's rated capacity.

In some embodiments, the iron-air battery may be used in apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), or the like. For example, “long duration” and/or “ultra-long duration” iron-air batteries may refer to iron-air batteries that may be configured to store energy over time spans of days, weeks, or seasons. In some embodiments, the iron-air batteries may be configured to store energy generated by solar cells during the summer months, when the sunshine is plentiful and solar power generation exceeds power grid requirements, and discharge the stored energy during the winter months, when the sunshine may be insufficient to satisfy power grid requirements.

In some embodiments, the iron-air battery may be incorporated into apparatus, systems, and methods for energy storage for shorter durations of less than about 8 hours. For example, the iron-air battery may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, the iron-air battery system may include energy storage used as backup power when the electricity supplied by the power grid is insufficient, for installations including homes, commercial buildings, factories, hospitals, or data centers, where the required discharge duration may vary from a few minutes to several days.

This disclosure is further illustrated by the following examples, which are non-limiting.

### Examples

The following results were modeled using COMSOL software's battery module. Iron electrode ribs were treated as porous electrode domains, with Ohm's law for electron transport in the iron, ionic diffusion, and migration in the electrolyte, and Butler-Volmer kinetics for both iron and hydrogen reactions. The volume fraction of iron hydroxide increases during discharge, leading to corresponding decrease in the iron and electrolyte volume fractions, and vice-versa on charge.

Instantaneous coulombic efficiency is defined as (rate of iron reaction)/(rate of iron reaction+rate of hydrogen reaction). Resistance is defined as the (OCV-V)/I, where OCV is the open-circuit voltage, V is the voltage on load, and I is the current per apparent area. OCV and V are measured with respect to a reference electrode in the separation. The interdigitated and channeled configurations had the same areal loading of 4 g Fe/cm² as the planar configuration; therefore, the interdigitated and channeled configuration had thicker iron electrodes than the planar configuration, since some space is occupied by the channels. Charge was simulated at 6 mA/g_Fe, whereas discharge was simulated at 3 mA/g_Fe. The initial porosity in the ribs was set at 0.6. The electrolyte was 6 M KOH at 303 K. Herein, w_rib may be defined as half the rib width, i.e., 0.5*RW. In the channeled and interdigitated simulations, the channel fraction was 0.4 and w_rib was 5 mm.

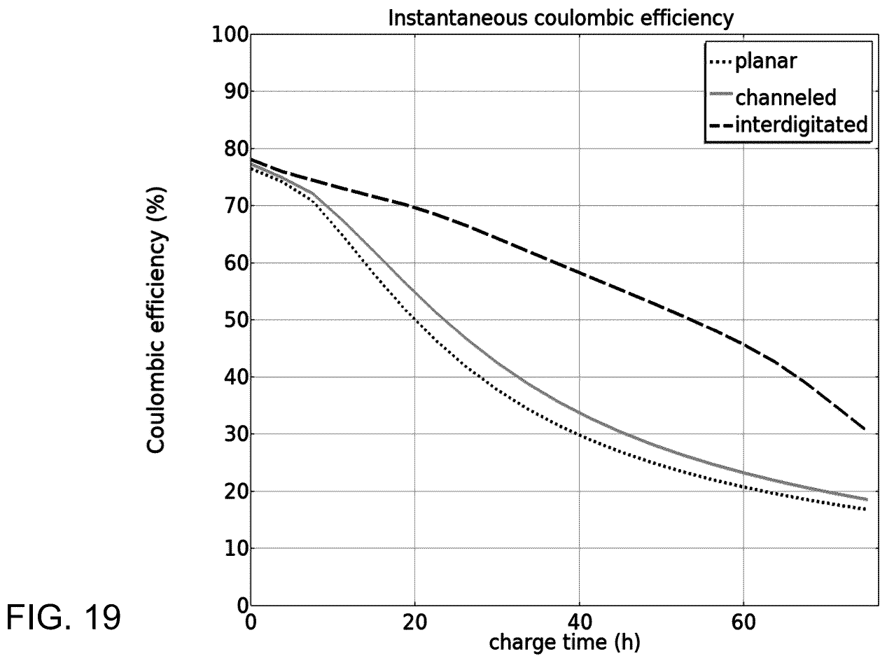

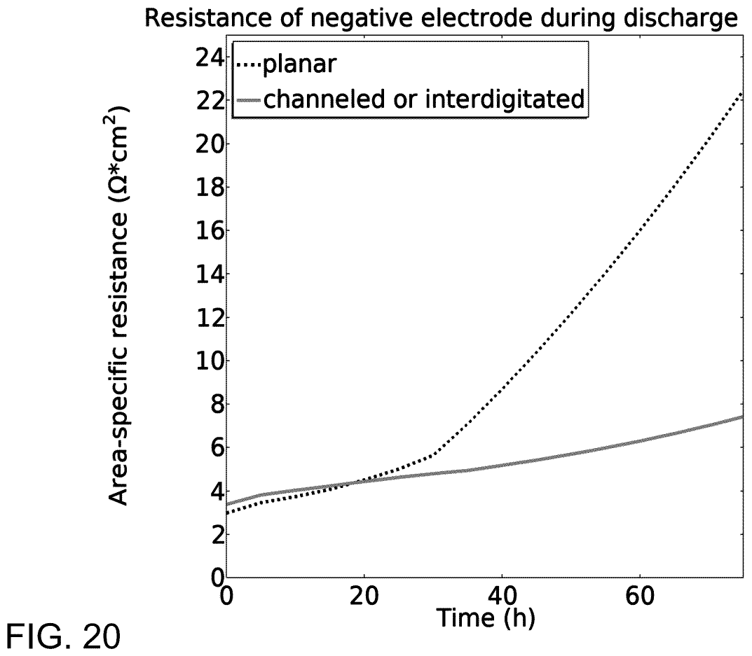

FIGS. 19 and 20 are graphs respectively showing simulated instantaneous coulombic charge efficiency and discharge resistance, for iron-air cells including planar iron and charge positive electrodes, channeled iron electrodes and planar charge positive electrodes, or channeled iron electrodes and interdigitated charge positive electrodes.

FIG. 19 shows that the planar geometry was projected to suffer from low coulombic efficiency, particularly towards the end of charging. The charge reaction converts iron hydroxide to iron metal. At the beginning of charge, the reaction occurs mostly near the front of the electrode. When the iron hydroxide in the front is consumed, the reaction must shift towards the back of the electrode to access more iron hydroxide. However, the reactant for hydrogen evolution is water. Water can flow into the electrode to replenish consumed water. Therefore, hydrogen evolution can continue at the front of the electrode. There is higher resistance to reacting the back of the electrode because ions in the electrolyte must travel farther to access the back of the electrode. The reaction will distribute itself in such a way as to minimize the overall cell resistance. If it is higher resistance to travel to the back of the electrode to consume iron hydroxide, than to evolve hydrogen at the front of the electrode, then the reaction will preferentially shift to hydrogen evolution. The front of the electrode is the side closest to the counter electrode.

The channeled design was calculated to provide a modest improvement in coulombic efficiency, because the channels provide a lower-resistance path for ions to travel to the back of the electrode. The interdigitated design was predicted to provide a significant increase in the coulombic efficiency, because the interdigitated geometry significantly lowers the ionic pathlength from the charge positive electrode to the entire area of the iron electrode.

FIG. 20 shows that the resistance during discharge was predicted to be the same for the channeled and interdigitated geometries, because both designs have the same geometry for the discharge positive electrode. At the beginning of discharge, the iron metal at the front of the iron electrode reacts to form iron hydroxide. As the iron becomes covered with iron hydroxide, the reaction shifts towards the back of the electrode. Because ions in the electrolyte must travel farther to reach the back of the electrode, there is more potential drop in solution, and thus the resistance increases with time during discharge. The channeled iron electrode has lower resistance at end of discharge than the planar iron electrode because the channels provide lower-resistance paths for ions to transport to the back of the iron electrode.

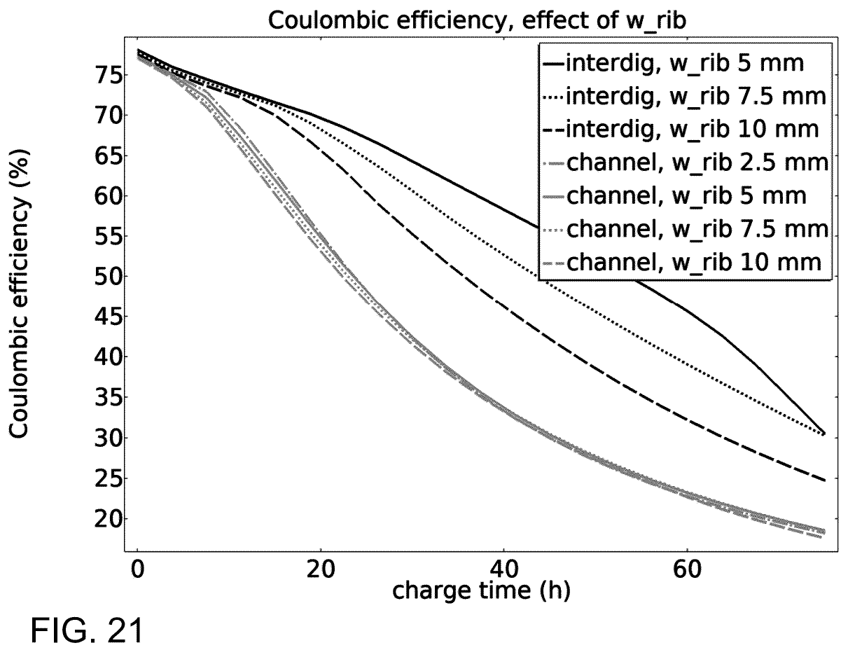

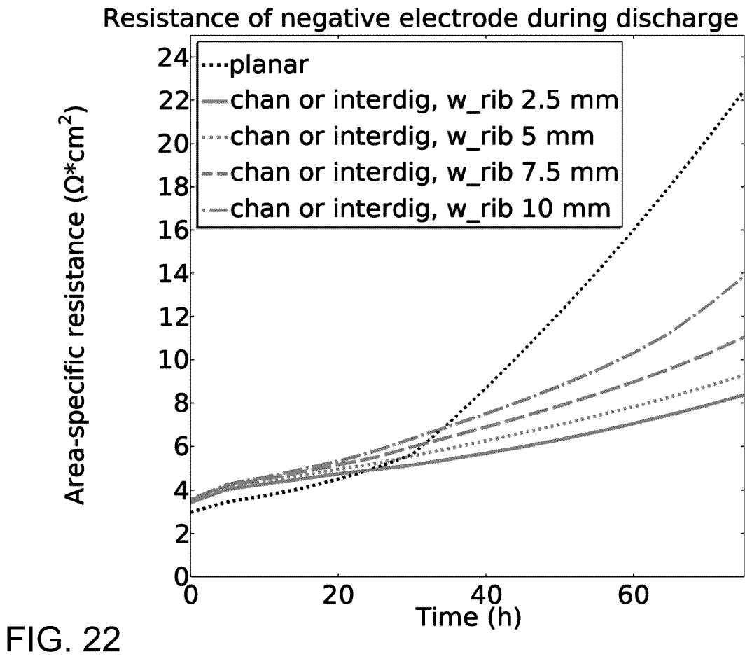

FIG. 21 is a graph showing simulated coulombic efficiency of channeled and interdigitated cells having different rib widths. FIG. 22 is a graph showing simulated discharge resistances during discharge of channeled and interdigitated cells having different rib widths. In the simulations, channel fraction is 0.4 and loading is 4 g Fe/cm².

Referring to FIGS. 21 and 22, the simulations predicted that the coulombic efficiency of the channeled cell is less sensitive to rib width, because it is more dominated by gradients in the thru-plane direction. Interdigitating the charge positive electrode removes the thru-plane gradients during charge, increasing the coulombic efficiency to the point where we can see its sensitivity to rib width. Resistance increases with time because the ions in the electrolyte have to travel further through the iron electrode to reach iron reactant. A larger travel distance causes the resistance to have a steeper slope vs. amount of charge passed.

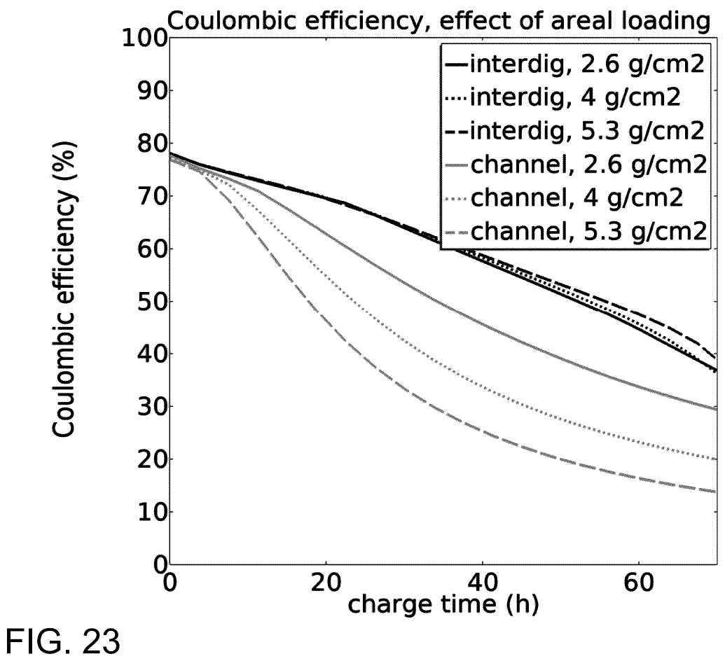

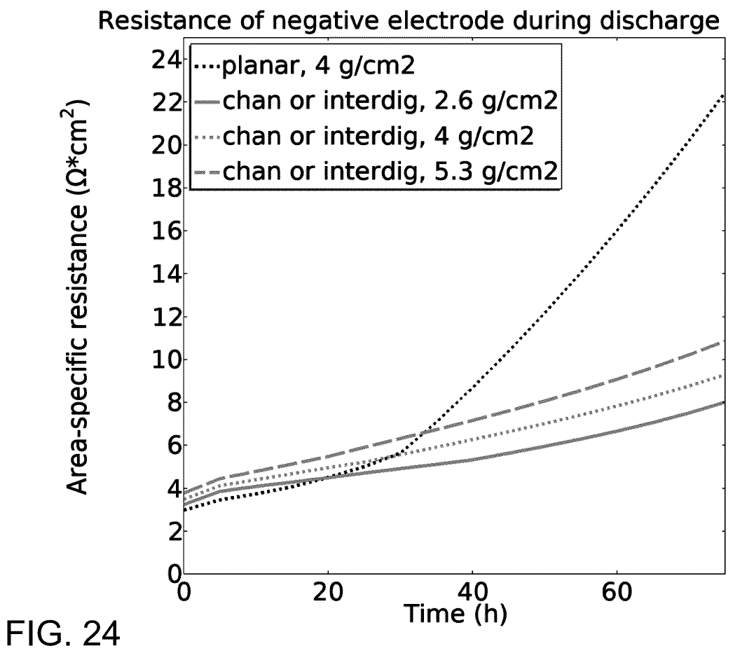

FIG. 23 is a graph showing predicted coulombic efficiency of channeled and interdigitated cells having different areal loadings, with a higher loading meaning a thicker electrode at the same density for the iron electrode. FIG. 24 is a graph showing predicted area-specific resistance during discharge interdigitated cells having different areal loadings. Referring to FIGS. 23 and 24, the coulombic efficiency of the channeled electrode is a strong function of areal loading, because a thicker electrode means the ions have farther to travel to reach reactant. The coulombic efficiency of the interdigitated electrode is fairly independent of loading because the path from OER electrode to iron reactant is perpendicular to the electrode thickness direction.

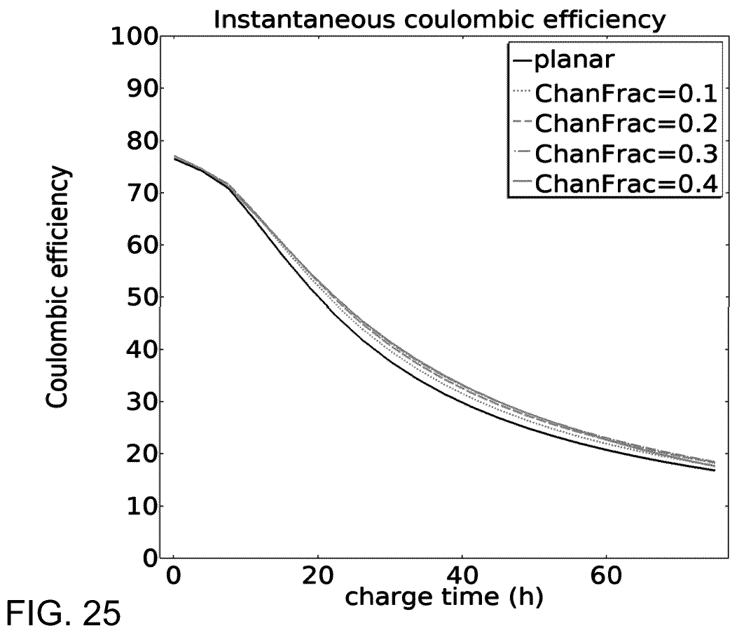

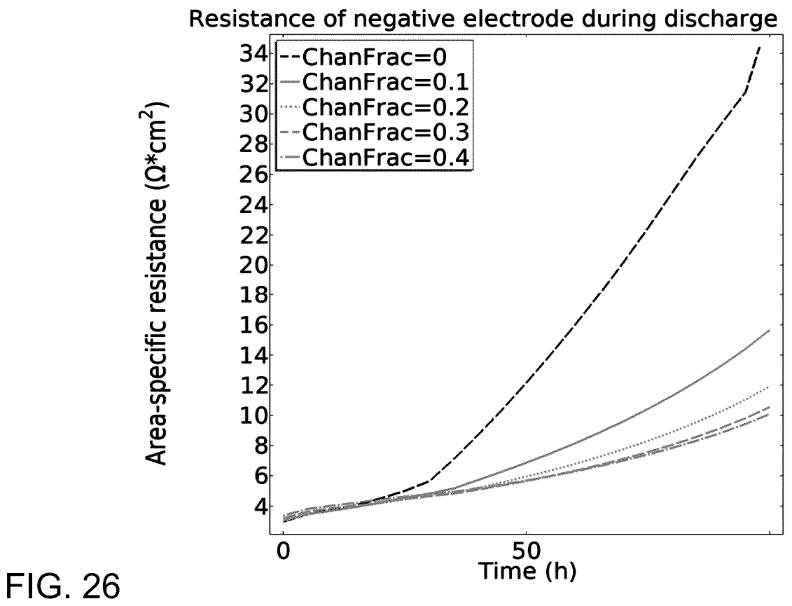

FIG. 25 is a graph showing the predicted effect of channel fraction on performance of the channeled iron electrodes. FIG. 26 is a graph showing simulated negative electrode resistance during discharge. Referring to FIGS. 25 and 26, ChanFrac=CW/(CW+RW). ChanFrac is the porosity introduced by channels. In the interdigitated design, the channel must be wide enough to accommodate a charge positive electrode and optionally a separator. This constrains the channel fraction to be at least 0.4 for w_rib of about 5 mm. Because wider channels introduce costs of additional electrolyte and additional packaging (casing) material, cost considerations may guide one to select a narrower channel fraction.

The channel serves to provide a low-tortuosity path for electrolyte transport. The ribs can therefore have lower porosity than if there were no channels in an iron electrode. Having low porosity in the ribs can facilitate particle-particle contact.

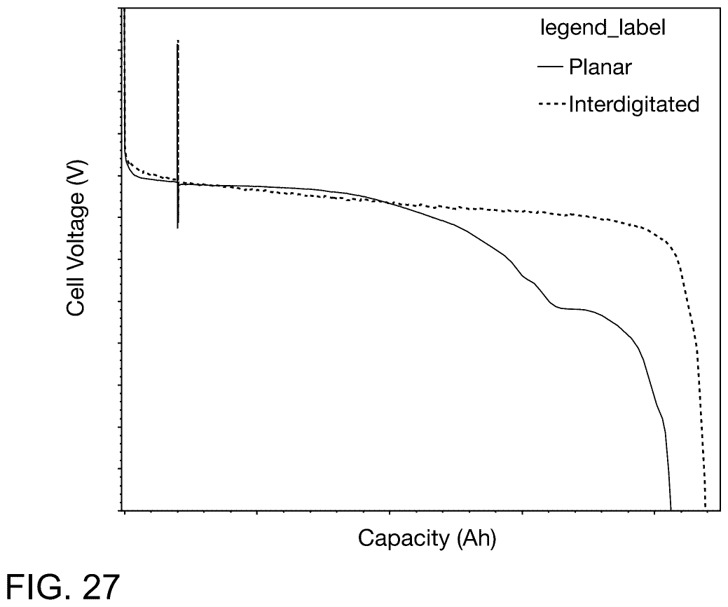

FIG. 27 is a graph with representative experimental data showing discharge voltage as a function of capacity collected from two iron-air battery cells. Both cells contained an iron negative electrode, ORR discharge positive electrode, and OER charge positive electrode. The cell labeled “Planar” was the control cell with configuration similar to that shown in FIG. 1. The cell labeled “Interdigitated” was the experimental cell with interdigitated OER electrode configuration similar to that shown in FIG. 15. All experimental parameters other than the configuration of the iron electrode and OER electrode were held constant across the two cells, including iron electrode surface density, temperature, charge and discharge current, electrolyte composition, and ORR electrode composition and geometry. With increasing discharge capacity, the experimental cell with channeled iron electrode and interdigitated configuration showed an extended upper voltage plateau compared to the planar control cell. This result was in alignment with COMSOL simulations shown in FIG. 20. The extended discharge voltage plateau in the iron electrode with channels indicated reduced resistance increase during the course of discharge compared to the planar control cell. This resulted in enhanced average discharge voltage and greater energy storage capacity in the experimental interdigitated cell compared to the planar control cell.

This disclosure further encompasses the following embodiments.

Aspect 1. An iron-air battery, comprising: an iron electrode in contact with an anode current collector, wherein the iron electrode comprises a plurality of channels; an oxygen reduction reaction electrode having a first surface facing the plurality of channels and an opposing second surface in contact with air; an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode; and an electrolyte in contact with the iron electrode, the first surface of the oxygen reduction reaction electrode, the plurality of channels, and the oxygen evolution reaction electrode.

Aspect 2. The iron-air battery of aspect 1, further comprising a separator disposed between at least a portion of the iron electrode and the oxygen evolution reaction electrode.

Aspect 3. The iron-air battery of aspect 1 or 2, wherein the oxygen evolution reaction electrode comprises: a plurality of cathode projections disposed within the plurality of channels; and a trunk portion connected to the plurality of cathode projections, wherein the trunk portion is not interdigitated with the plurality of channels of the iron electrode, and wherein the trunk portion is disposed between the iron electrode and the oxygen reduction reaction electrode.

Aspect 4. The iron-air battery of aspect 3, wherein one or more cathode projections of the plurality of cathode projections has an average length of 3 mm to 50 mm when measured from the trunk portion.

Aspect 5. The iron-air battery of any one of aspects 1 to 4, wherein greater than 25% of channels in the plurality of channels comprise the oxygen evolution reaction electrode disposed therein.

Aspect 6. The iron-air battery of any one of aspects 1 to 5, wherein one or more channels of the plurality of channels further comprises an additive.

Aspect 7. The iron-air battery of any one of aspects 1 to 6, wherein one or more channels of the plurality of channels has an average length of 3 mm to 50 mm in a direction perpendicular to the plane of the oxygen reduction reaction electrode, and an average width of 1 mm to 40 mm in a direction parallel to the plane of the oxygen reduction reaction electrode.

Aspect 8. The iron-air battery of any one of aspects 1 to 7, wherein one or more channels of the plurality of channels has an average width of 1 mm to 40 mm in a direction parallel to the plane of the oxygen reduction reaction electrode.

Aspect 9. The iron-air battery of any one of aspects 1 to 8, wherein one or more channels of the plurality of channels are separated from each other by an average distance of 10 mm to 50 mm in a direction parallel to the plane of the oxygen reduction reaction electrode, when measured between centers of adjacent channels.

Aspect 10. The iron-air battery of any one of aspects 1 to 9, wherein each channel of the plurality of channels independently has a rectangular prism shape, a cylindrical shape, a pyramidal shape, or a trapezoidal prism shape.

Aspect 11. The iron-air battery of any one of aspects 1 to 10, wherein the oxygen evolution reaction electrode comprises a porous metal mesh and an oxygen evolution catalyst.

Aspect 12. The iron-air battery of any one of aspects 1 to 11, wherein the oxygen evolution reaction electrode is arranged in a corrugated configuration within the plurality of channels.

Aspect 13. The iron-air battery of any one of aspects 1 to 12, wherein the anode current collector comprises: one or more branch current collectors disposed parallel to the plurality of channels; and a primary current collector connected to the one or more branch current collectors, wherein the primary current collector is disposed parallel to the first surface of the oxygen reduction reaction electrode.

Aspect 14. The iron-air battery of any one of aspects 1 to 13, wherein the electrolyte comprises a solid oxide electrolyte, a solid polymer electrolyte, a molten salt, an aqueous solution, a non-aqueous solution, a gel, or a combination thereof.

Aspect 15. The iron-air battery of any one of aspects 1 to 14, wherein the electrolyte comprises an aqueous solution of an alkali hydroxide, an organic hydroxide, or a combination thereof.

Aspect 16. The iron-air battery of any one of aspects 1 to 15, wherein the iron electrode has a surface density of 1 gram of iron per square centimeter to 7 grams of iron per square centimeter relative to a direction perpendicular to the oxygen reduction reaction electrode.

Aspect 17. The iron-air battery of any one of aspects 1 to 16, wherein a volume fraction of the electrolyte in the iron electrode is 0.5 to 0.9, based on the total volume of the iron electrode when fully charged.

Aspect 18. The iron-air battery of any one of aspects 1 to 17, wherein the anode current collector comprises a first surface and an opposite second surface, the iron electrode comprises a first iron electrode on the first surface of a first current collector, and a second iron electrode on the second surface of the first current collector, wherein the first iron electrode comprises a first plurality of channels and the second iron electrode comprises a second plurality of channels; the oxygen reduction reaction electrode has a first surface facing the first plurality of channels and an opposing second surface in contact with air; the oxygen evolution reaction electrode is interdigitated with the first plurality of channels of the first iron electrode, wherein at least a portion of the oxygen evolution reaction electrode is disposed within the first plurality of channels in a direction perpendicular to the plane of the oxygen reduction reaction electrode; the first electrolyte is in contact with the first iron electrode, the first surface of the oxygen reduction reaction electrode, the first plurality of channels, and the oxygen evolution reaction electrode; and wherein the iron-air battery further comprises: a second oxygen reduction reaction electrode having a first surface facing the second plurality of channels and an opposing second surface in contact with air; a second oxygen evolution reaction electrode interdigitated with the second plurality of channels of the second iron electrode, wherein at least a portion of the second oxygen evolution reaction electrode is disposed within the second plurality of channels in a direction perpendicular to a plane of the second oxygen reduction reaction electrode; and a second electrolyte in contact with the second iron electrode, the first surface of the oxygen reduction reaction electrode, the second plurality of channels, and the second oxygen evolution reaction electrode, wherein the electrolyte and the second electrolyte are the same or different.

Aspect 19. The iron-air battery of any one of aspects 1 to 17, further comprising a second iron electrode in contact with a second anode current collector, wherein the second iron electrode comprises a second plurality of channels; a second oxygen reduction reaction electrode having a first surface facing the second plurality of channels and an opposing second surface in contact with air; a second oxygen evolution reaction electrode interdigitated with the second plurality of channels of the second iron electrode, wherein at least a portion of the second oxygen evolution reaction electrode is disposed within the second plurality of channels in a direction perpendicular to a plane of the second oxygen reduction reaction electrode; a second electrolyte in contact with the second iron electrode, the first surface of the second oxygen reduction reaction electrode, the second plurality of channels, and the second oxygen evolution reaction electrode; and an air channel disposed between the second surface of the oxygen reduction reaction electrode and the second surface of the second oxygen reduction reaction, wherein the electrolyte and the second electrolyte are the same or different.

Aspect 20. An iron-air battery, comprising: an iron electrode comprising a plurality of anodes separated by a plurality of channels, wherein the plurality of anodes is in electrical communication with each other; an oxygen reduction reaction electrode having a first surface facing the plurality of channels and an opposing second surface in contact with air; an oxygen evolution reaction electrode interdigitated with the plurality of channels, wherein at least a portion of the oxygen evolution reaction electrode is disposed within the plurality of channels in a direction perpendicular to a plane of the oxygen reduction reaction electrode; and an electrolyte in contact with the iron electrode, the first surface of the oxygen reduction reaction electrode, the plurality of channels, and the oxygen evolution reaction electrode.

Aspect 21. The iron-air battery of aspect 20, wherein each anode of the plurality of anodes is in contact with an anode current collector.

Aspect 22. The iron-air battery of aspect 20 or 21, further comprising a separator disposed between at least a portion of the iron electrode and the oxygen evolution reaction electrode.

Aspect 23. The iron-air battery of any one of aspects 20 to 22, wherein the oxygen evolution reaction electrode comprises: a plurality of cathode projections disposed within the plurality of channels; and a trunk portion connected to the plurality of cathode projections, wherein the trunk portion is not interdigitated with the plurality of channels of the iron electrode, and wherein the trunk portion is disposed between the iron electrode and the oxygen reduction reaction electrode.

Aspect 24. The iron-air battery of any one of aspects 20 to 23, wherein one or more cathode projections of the plurality of cathode projections has an average length of 3 mm to 50 mm when measured from the trunk portion.

Aspect 25. The iron-air battery of any one of aspects 20 to 24, wherein greater than 25% of channels in the plurality of channels comprise the oxygen evolution reaction electrode disposed therein.

Aspect 26. The iron-air battery of any one of aspects 20 to 25, wherein one or more channels of the plurality of channels further comprises an additive.

Aspect 27. The iron-air battery of any one of aspects 20 to 26, wherein one or more anodes of the plurality of anodes has an average length of 3 mm to 50 mm in a direction perpendicular to the plane of the oxygen reduction reaction electrode, and an average width of 1 mm to 40 mm in a direction parallel to the plane of the oxygen reduction reaction electrode.

Aspect 28. The iron-air battery of any one of aspects 20 to 27, wherein two or more anodes of the plurality of anodes are separated from each other by an average distance of 10 mm to 50 mm in a direction parallel to the plane of the oxygen reduction reaction electrode.

Aspect 29. The iron-air battery of any one of aspects 20 to 28, wherein the oxygen evolution reaction electrode comprises a porous metal mesh and an oxygen evolution catalyst.

Aspect 30. The iron-air battery of any one of aspects 20 to 29, wherein each anode of the plurality of anodes is in contact with a branch current collector, wherein each branch current collector is connected a primary current collector that is disposed parallel to the first surface of the oxygen reduction reaction electrode.

Aspect 31. The iron-air battery of any one of aspects 20 to 30, wherein each anode of the plurality of anodes is in contact with a branch current collector, wherein the each branch current collector is connected to a primary current collector that is disposed parallel to the first surface of the oxygen reduction reaction electrode, wherein the primary current collector is disposed outside a plane defining an active area of the iron electrode, the oxygen evolution reaction electrode, and the oxygen reduction reaction electrode.

Aspect 32. The iron-air battery of any one of aspects 20 to 31, wherein the oxygen evolution reaction electrode is disposed in a serpentine configuration in the plurality of channels between the plurality of anodes.

Aspect 33. The iron-air battery of any one of aspects 20 to 32, further comprising a second oxygen reduction reaction electrode having a first surface facing the plurality of channels and an opposing second surface in contact with air, wherein a plane of the second oxygen reduction reaction electrode is parallel to the plane of the oxygen reduction reaction electrode.

Aspect 34. The iron-air battery of any one of aspects 20 to 33, wherein the electrolyte comprises a solid oxide electrolyte, a solid polymer electrolyte, a molten salt, an aqueous solution, a non-aqueous solution, a gel, or a combination thereof.

Aspect 35. The iron-air battery of any one of aspects 20 to 34, wherein the electrolyte comprises an aqueous solution of an alkali hydroxide, an organic hydroxide, or a combination thereof.

Aspect 36. The iron-air battery of any one of aspects 20 to 35, wherein each anode of the iron electrode has a surface density of 1 gram of iron per square centimeter to 7 grams of iron per square centimeter relative to a direction perpendicular to the oxygen reduction reaction electrode.

Aspect 37. The iron-air battery of any one of aspects 20 to 36, wherein a volume fraction of the electrolyte in the iron electrode is 0.5 to 0.9, based on the total volume of the iron electrode when fully charged.

Aspect 38. An iron-air battery, comprising: an iron electrode comprising a plurality of anodes separated by a plurality of channels, wherein the plurality of anodes is in electrical communication with each other; an oxygen reduction reaction electrode having a first surface facing the plurality of channels and an opposing second surface in contact with air; an oxygen evolution reaction electrode comprising a plurality of cathodes interdigitated with the plurality of anodes, wherein the plurality of cathodes is disposed within the plurality of channels in a direction perpendicular to a plane of the oxygen reduction reaction electrode, and wherein the plurality of cathodes is in electrical communication with each other; and an electrolyte in contact with the iron electrode, the first surface of the oxygen reduction reaction electrode, the plurality of channels, and the oxygen evolution reaction electrode.

Aspect 39. The iron-air battery of aspect 38, wherein each anode of the plurality of anodes is in contact with an anode current collector.

Aspect 40. The iron-air battery of aspect 38 or 39, further comprising a separator disposed between at least a portion of the plurality of anodes and the plurality of cathodes.

Aspect 41. The iron-air battery of any one of aspects 38 to 40, wherein one or more cathodes of the plurality of cathodes has an average length of 3 mm to 50 mm when measured in a direction perpendicular to a plane of the oxygen reduction reaction electrode.

Aspect 42. The iron-air battery of any one of aspects 38 to 41, wherein greater than 25% of channels in the plurality of channels comprise the oxygen evolution reaction electrode disposed therein.

Aspect 43. The iron-air battery of any one of aspects 38 to 42, wherein one or more channels of the plurality of channels further comprises an additive.

Aspect 44. The iron-air battery of any one of aspects 38 to 43, wherein one or more anodes of the plurality of anodes has an average length of 3 mm to 50 mm in a direction perpendicular to the plane of the oxygen reduction reaction electrode, and an average width of 1 mm to 40 mm in a direction parallel to the plane of the oxygen reduction reaction electrode.

Aspect 45. The iron-air battery of any one of aspects 38 to 44, wherein two or more anodes of the plurality of anodes are separated from each other by an average distance of 10 mm to 50 mm in a direction parallel to the plane of the oxygen reduction reaction electrode.

Aspect 46. The iron-air battery of any one of aspects 38 to 45, wherein each anode of the plurality of anodes is in contact with a branch current collector, wherein each branch current collector is connected a primary current collector that is disposed parallel to the first surface of the oxygen reduction reaction electrode.

Aspect 47. The iron-air battery of any one of aspects 38 to 46, wherein each anode of the plurality of anodes is in contact with a branch current collector, wherein the each branch current collector is connected a primary current collector that is disposed parallel to the first surface of the oxygen reduction reaction electrode, wherein the primary current collector is disposed outside a plane defining an active area of the iron electrode, the oxygen evolution reaction electrode, and the oxygen reduction reaction electrode.

Aspect 48. The iron-air battery of any one of aspects 38 to 47, wherein each cathode of the plurality of cathodes is in contact with a cathode current collector, wherein the cathode current collector is disposed outside a plane defining an active area of the iron electrode, the oxygen evolution reaction electrode, and the oxygen reduction reaction electrode.

Aspect 49. The iron-air battery of any one of aspects 38 to 48, further comprising a second oxygen reduction reaction electrode having a first surface facing the plurality of channels and an opposing second surface in contact with air, wherein a plane of the second oxygen reduction reaction electrode is parallel to the plane of the oxygen reduction reaction electrode.

Aspect 50. The iron-air battery of any one of aspects 38 to 49, wherein the electrolyte comprises a solid oxide electrolyte, a solid polymer electrolyte, a molten salt, an aqueous solution, a non-aqueous solution, a gel, or a combination thereof.

Aspect 51. The iron-air battery of any one of aspects 38 to 50, wherein the electrolyte comprises an aqueous solution of an alkali hydroxide, an organic hydroxide, or a combination thereof.

Aspect 52. The iron-air battery of any one of aspects 38 to 51, wherein each anode of the iron electrode has a surface density of 1 gram of iron per square centimeter to 7 grams of iron per square centimeter relative to a direction perpendicular to the oxygen reduction reaction electrode.

Aspect 53. The iron-air battery of any one of aspects 38 to 52, wherein a volume fraction of the electrolyte in the iron electrode is 0.5 to 0.9, based on the total volume of the iron electrode when fully charged.

Aspect 54. The iron-air battery of any one of aspects 38 to 53, wherein the plurality of cathodes each comprises an oxygen evolution catalyst.

Aspect 55. An iron-air battery, comprising: an iron electrode in contact with an anode current collector, wherein the iron electrode comprises a plurality of channels; an oxygen reduction reaction electrode having a first surface facing the plurality of channels and an opposing second surface in contact with air; an oxygen evolution reaction electrode comprising a plurality of cathodes interdigitated with the iron electrode, wherein the plurality of cathodes is disposed within the plurality of channels in a direction perpendicular to a plane of the oxygen reduction reaction electrode, and wherein the plurality of cathodes is in electrical communication with each other; and an electrolyte in contact with the iron electrode, the first surface of the oxygen reduction reaction electrode, the plurality of channels, and the oxygen evolution reaction electrode.

Aspect 56. The iron-air battery of aspect 55, further comprising a separator disposed between at least a portion of the iron electrode and the plurality of cathodes.

Aspect 57. The iron-air battery of aspect 55 or 56, wherein one or more cathodes of the plurality of cathodes has an average length of 3 mm to 50 mm when measured in a direction perpendicular to a plane of the oxygen reduction reaction electrode.

Aspect 58. The iron-air battery of any one of aspects 55 to 57, wherein greater than 25% of channels in the plurality of channels comprise a cathode of the plurality of cathodes disposed therein.

Aspect 59. The iron-air battery of any one of aspects 55 to 58, wherein one or more channels of the plurality of channels further comprises an additive.

Aspect 60. The iron-air battery of any one of aspects 55 to 59, wherein one or more channels of the plurality of channels has an average length of 3 mm to 50 mm in a direction perpendicular to the plane of the oxygen reduction reaction electrode, and an average width of 1 mm to 40 mm in a direction parallel to the plane of the oxygen reduction reaction electrode.

Aspect 61. The iron-air battery of any one of aspects 55 to 60, wherein one or more channels of the plurality of channels has an average width of 1 mm to 40 mm in a direction parallel to the plane of the oxygen reduction reaction electrode, wherein a first width that is closest to the oxygen reduction reaction electrode is 1% to 500% greater than a second width that is furthest from the oxygen reduction reaction electrode.

Aspect 62. The iron-air battery of any one of aspects 55 to 61, wherein one or more channels of the plurality of channels are separated from each other by an average distance of 10 mm to 50 mm in a direction parallel to the plane of the oxygen reduction reaction electrode, when measured between centers of adjacent channels.

Aspect 63. The iron-air battery of any one of aspects 55 to 62, wherein each channel of the plurality of channels independently has a rectangular prism shape, a cylindrical shape, a pyramidal shape, or a trapezoidal prism shape.

Aspect 64. The iron-air battery of any one of aspects 55 to 63, wherein each cathode of the plurality of cathodes is in contact with a cathode current collector, wherein the cathode current collector is disposed outside a plane defining an active area of the iron electrode, the oxygen evolution reaction electrode, and the oxygen reduction reaction electrode.

Aspect 65. The iron-air battery of any one of aspects 50 to 64, wherein the anode current collector comprises: one or more branch current collectors disposed parallel to the plurality of channels; and a primary current collector connected to the one or more branch current collectors, wherein the primary current collector is disposed parallel to the first surface of the oxygen reduction reaction electrode.

Aspect 66. The iron-air battery of any one of aspects 50 to 65, wherein the electrolyte comprises a solid oxide electrolyte, a solid polymer electrolyte, a molten salt, an aqueous solution, a non-aqueous solution, a gel, or a combination thereof.

Aspect 67. The iron-air battery of any one of aspects 55 to 66, wherein the electrolyte comprises an aqueous solution of an alkali hydroxide, an organic hydroxide, or a combination thereof.

Aspect 68. The iron-air battery of any one of aspects 55 to 67, wherein the iron electrode has a surface density of 1 gram of iron per square centimeter to 7 grams of iron per square centimeter relative to a direction perpendicular to the oxygen reduction reaction electrode.

Aspect 69. The iron-air battery of any one of aspects 55 to 68, wherein a volume fraction of the electrolyte in the iron electrode is 0.5 to 0.9, based on the total volume of the iron electrode when fully charged.

Aspect 70. An iron-air battery, comprising: an iron electrode in contact with an anode current collector, wherein the iron electrode and the anode current collector are arranged in a spiral configuration; an oxygen reduction reaction electrode having a first surface facing an axis of rotation of the spiral configuration and an opposing second surface in contact with air; an oxygen evolution reaction electrode arranged in a spiral configuration and interdigitated with the iron electrode, wherein the iron electrode and the oxygen evolution reaction electrode are at least partially bifilar; and an electrolyte in contact with the iron electrode, the first surface of the oxygen reduction reaction electrode, and the oxygen evolution reaction electrode.

Aspect 71. The iron-air battery of aspect 70, further comprising a separator disposed between at least a portion of the iron electrode and the oxygen evolution reaction electrode.

Aspect 72. The iron-air battery of aspect 70 or 71, further comprising a second oxygen reduction reaction electrode having a first surface facing the axis of rotation of the spiral configuration and an opposing second surface in contact with air, wherein a plane of the second oxygen reduction reaction electrode is parallel to the plane of the oxygen reduction reaction electrode.

Aspect 73. The iron-air battery of any one of aspects 70 to 72, wherein the electrolyte comprises a solid oxide electrolyte, a solid polymer electrolyte, a molten salt, an aqueous solution, a non-aqueous solution, a gel, or a combination thereof.

Aspect 74. The iron-air battery of any one of aspects 70 to 73, wherein the electrolyte comprises an aqueous solution of an alkali hydroxide, an organic hydroxide, or a combination thereof.

Aspect 75. The iron-air battery of any one of aspects 70 to 74, wherein each anode of the iron electrode has a surface density of 1 gram of iron per square centimeter to 7 grams of iron per square centimeter relative to a direction perpendicular to the oxygen reduction reaction electrode.

Aspect 76. The iron-air battery of any one of aspects 70 to 75, wherein a volume fraction of the electrolyte in the iron electrode is 0.5 to 0.9, based on the total volume of the iron electrode when fully charged.

Aspect 77. An iron-air battery, comprising: an iron electrode in contact with an anode current collector, wherein the iron electrode and the anode current collector are arranged in a pleated configuration, and wherein the iron electrode comprises a plurality of channels between the pleats; an oxygen reduction reaction electrode having a first surface facing the plurality of channels and an opposing second surface in contact with air; an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode, and wherein the oxygen evolution reaction electrode is arranged in a pleated configuration; and an electrolyte in contact with the iron electrode, the first surface of the oxygen reduction reaction electrode, the plurality of channels, and the oxygen evolution reaction electrode.

Aspect 78. The iron-air battery of aspect 77, further comprising a separator disposed between at least a portion of the iron electrode and the oxygen evolution reaction electrode.

Aspect 79. The iron-air battery of aspect 77 or 78, wherein the oxygen evolution reaction electrode comprises a porous metal mesh and an oxygen evolution catalyst.

Aspect 80. The iron-air battery of any one of aspects 77 to 79, wherein the oxygen evolution reaction electrode is arranged at a first surface of the iron electrode, and further comprising a second oxygen evolution reaction electrode interdigitated with the plurality of channels of the iron electrode, wherein the second oxygen evolution reaction electrode is arranged at a second opposing surface of the iron electrode, wherein at least a portion of the second oxygen evolution reaction electrode is disposed within the plurality of channels in a direction perpendicular to a plane of the oxygen reduction reaction electrode, and wherein the second oxygen evolution reaction electrode is arranged in a pleated configuration.

Aspect 81. The iron-air battery of any one of aspects 77 to 80, further comprising a second oxygen reduction reaction electrode having a first surface facing the plurality of channels and an opposing second surface in contact with air, wherein a plane of the second oxygen reduction reaction electrode is parallel to the plane of the oxygen reduction reaction electrode.

Aspect 82. The iron-air battery of any one of aspects 77 to 81, wherein the electrolyte comprises a solid oxide electrolyte, a solid polymer electrolyte, a molten salt, an aqueous solution, a non-aqueous solution, a gel, or a combination thereof.

Aspect 83. The iron-air battery of any one of aspects 77 to 82, wherein the electrolyte comprises an aqueous solution of an alkali hydroxide, an organic hydroxide, or a combination thereof.

Aspect 84. The iron-air battery of any one of aspects 77 to 83, wherein each anode of the iron electrode has a surface density of 1 gram of iron per square centimeter to 7 grams of iron per square centimeter relative to a direction perpendicular to the oxygen reduction reaction electrode.

Aspect 85. The iron-air battery of any one of aspects 77 to 84, wherein a volume fraction of the electrolyte in the iron electrode is 0.5 to 0.9, based on the total volume of the iron electrode when fully charged.

Aspect 86. A method of forming the iron-air battery of any one of aspects 1 to 19, the method comprising: forming an iron negative electrode material onto an anode current collector to form the iron electrode comprising a plurality of channels; disposing the oxygen evolution reaction electrode into one or more channels of the iron electrode; and assembling the oxygen reduction reaction electrode having the first surface facing the iron electrode and the opposing second surface in contact with air to form an electrode assembly.

Aspect 87. The method of aspect 86, wherein the forming comprises compressing the iron negative electrode material onto a current collector to form the plurality of channels disposed in the iron electrode.

Aspect 88. The method of aspect 87, wherein the forming further comprises sintering.

Aspect 89. The method of any one of aspects 86 to 882, further comprising adding the electrolyte to the electrode assembly.

The compositions, methods, and articles can alternatively comprise, consist of, or consist essentially of, any appropriate materials, steps, or components herein disclosed. The compositions, methods, and articles can additionally, or alternatively, be formulated to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An iron-air battery, comprising:
an iron electrode in contact with an anode current collector, wherein the iron electrode comprises a plurality of channels;
an oxygen reduction reaction electrode having a first surface facing the plurality of channels and an opposing second surface in contact with air;
an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode; and
an electrolyte in contact with the iron electrode, the first surface of the oxygen reduction reaction electrode, the plurality of channels, and the oxygen evolution reaction electrode.

2. The iron-air battery of claim 1, further comprising a separator disposed between at least a portion of the iron electrode and the oxygen evolution reaction electrode.

3. The iron-air battery of claim 1, wherein the oxygen evolution reaction electrode comprises:
a plurality of cathode projections disposed within the plurality of channels; and
a trunk portion connected to the plurality of cathode projections, wherein the trunk portion is not interdigitated with the plurality of channels of the iron electrode, and wherein the trunk portion is disposed between the iron electrode and the oxygen reduction reaction electrode.

4. The iron-air battery of claim 3, wherein one or more cathode projections of the plurality of cathode projections has an average length of 3 mm to 50 mm when measured from the trunk portion.

5. The iron-air battery of claim 1, wherein greater than 25% of channels in the plurality of channels comprise the oxygen evolution reaction electrode disposed therein.

6. The iron-air battery of claim 1, wherein one or more channels of the plurality of channels further comprises an additive.

7. The iron-air battery of claim 1, wherein one or more channels of the plurality of channels has an average length of 3 mm to 50 mm in a direction perpendicular to the plane of the oxygen reduction reaction electrode, and an average width of 1 mm to 40 mm in a direction parallel to the plane of the oxygen reduction reaction electrode.

8. The iron-air battery of claim 1, wherein one or more channels of the plurality of channels has an average width of 1 mm to 40 mm in a direction parallel to the plane of the oxygen reduction reaction electrode.

9. The iron-air battery of claim 1, wherein one or more channels of the plurality of channels are separated from each other by an average distance of 10 mm to 50 mm in a direction parallel to the plane of the oxygen reduction reaction electrode, when measured between centers of adjacent channels.

10. The iron-air battery of claim 1, wherein each channel of the plurality of channels independently has a rectangular prism shape, a cylindrical shape, a pyramidal shape, or a trapezoidal prism shape.

11. The iron-air battery of claim 1, wherein the oxygen evolution reaction electrode comprises a porous metal mesh and an oxygen evolution catalyst.

12. The iron-air battery of claim 1, wherein the oxygen evolution reaction electrode is arranged in a corrugated configuration within the plurality of channels.

13. The iron-air battery of claim 1, wherein the anode current collector comprises:
one or more branch current collectors disposed parallel to the plurality of channels; and
a primary current collector connected to the one or more branch current collectors, wherein the primary current collector is disposed parallel to the first surface of the oxygen reduction reaction electrode.

14. The iron-air battery of claim 1, wherein the electrolyte comprises a solid oxide electrolyte, a solid polymer electrolyte, a molten salt, an aqueous solution, a non-aqueous solution, a gel, or a combination thereof.

15. The iron-air battery of claim 1, wherein the electrolyte comprises an aqueous solution of an alkali hydroxide, an organic hydroxide, or a combination thereof.

16. The iron-air battery of claim 1, wherein the iron electrode has a surface density of 1 gram of iron per square centimeter to 7 grams of iron per square centimeter relative to a direction perpendicular to the oxygen reduction reaction electrode.

17. The iron-air battery of claim 1, wherein a volume fraction of the electrolyte in the iron electrode is 0.5 to 0.9, based on the total volume of the iron electrode when fully charged.

18. The iron-air battery of claim 1, wherein
the anode current collector comprises a first surface and an opposite second surface,
the iron electrode comprises a first iron electrode on the first surface of a first current collector, and a second iron electrode on the second surface of the first current collector, wherein the first iron electrode comprises a first plurality of channels and the second iron electrode comprises a second plurality of channels;
the oxygen reduction reaction electrode has a first surface facing the first plurality of channels and an opposing second surface in contact with air;
the oxygen evolution reaction electrode is interdigitated with the first plurality of channels of the first iron electrode, wherein at least a portion of the oxygen evolution reaction electrode is disposed within the first plurality of channels in a direction perpendicular to the plane of the oxygen reduction reaction electrode;
the first electrolyte is in contact with the first iron electrode, the first surface of the oxygen reduction reaction electrode, the first plurality of channels, and the oxygen evolution reaction electrode; and
wherein the iron-air battery further comprises:
a second oxygen reduction reaction electrode having a first surface facing the second plurality of channels and an opposing second surface in contact with air;
a second oxygen evolution reaction electrode interdigitated with the second plurality of channels of the second iron electrode, wherein at least a portion of the second oxygen evolution reaction electrode is disposed within the second plurality of channels in a direction perpendicular to a plane of the second oxygen reduction reaction electrode; and
a second electrolyte in contact with the second iron electrode, the first surface of the oxygen reduction reaction electrode, the second plurality of channels, and the second oxygen evolution reaction electrode,
wherein the electrolyte and the second electrolyte are the same or different.

19. The iron-air battery of claim 1, further comprising
a second iron electrode in contact with a second anode current collector, wherein the second iron electrode comprises a second plurality of channels;
a second oxygen reduction reaction electrode having a first surface facing the second plurality of channels and an opposing second surface in contact with air;
a second oxygen evolution reaction electrode interdigitated with the second plurality of channels of the second iron electrode, wherein at least a portion of the second oxygen evolution reaction electrode is disposed within the second plurality of channels in a direction perpendicular to a plane of the second oxygen reduction reaction electrode;
a second electrolyte in contact with the second iron electrode, the first surface of the second oxygen reduction reaction electrode, the second plurality of channels, and the second oxygen evolution reaction electrode; and
an air channel disposed between the second surface of the oxygen reduction reaction electrode and the second surface of the second oxygen reduction reaction,
wherein the electrolyte and the second electrolyte are the same or different.

20. An iron-air battery, comprising:
an iron electrode comprising a plurality of anodes separated by a plurality of channels, wherein the plurality of anodes is in electrical communication with each other;
an oxygen reduction reaction electrode having a first surface facing the plurality of channels and an opposing second surface in contact with air;
an oxygen evolution reaction electrode interdigitated with the plurality of channels, wherein at least a portion of the oxygen evolution reaction electrode is disposed within the plurality of channels in a direction perpendicular to a plane of the oxygen reduction reaction electrode; and
an electrolyte in contact with the iron electrode, the first surface of the oxygen reduction reaction electrode, the plurality of channels, and the oxygen evolution reaction electrode.

21. The iron-air battery of claim 20, wherein each anode of the plurality of anodes is in contact with an anode current collector.

22. The iron-air battery of claim 20, further comprising a separator disposed between at least a portion of the iron electrode and the oxygen evolution reaction electrode.

23. The iron-air battery of claim 20, wherein the oxygen evolution reaction electrode comprises:
a plurality of cathode projections disposed within the plurality of channels; and
a trunk portion connected to the plurality of cathode projections, wherein the trunk portion is not interdigitated with the plurality of channels of the iron electrode, and wherein the trunk portion is disposed between the iron electrode and the oxygen reduction reaction electrode.

24. The iron-air battery of claim 20, wherein one or more cathode projections of the plurality of cathode projections has an average length of 3 mm to 50 mm when measured from the trunk portion.

25. The iron-air battery of claim 20, wherein greater than 25% of channels in the plurality of channels comprise the oxygen evolution reaction electrode disposed therein.

26. The iron-air battery of claim 20, wherein one or more channels of the plurality of channels further comprises an additive.

27. The iron-air battery of claim 20, wherein one or more anodes of the plurality of anodes has an average length of 3 mm to 50 mm in a direction perpendicular to the plane of the oxygen reduction reaction electrode, and an average width of 1 mm to 40 mm in a direction parallel to the plane of the oxygen reduction reaction electrode.

28. The iron-air battery of claim 20, wherein two or more anodes of the plurality of anodes are separated from each other by an average distance of 10 mm to 50 mm in a direction parallel to the plane of the oxygen reduction reaction electrode.

29. The iron-air battery of claim 20, wherein the oxygen evolution reaction electrode comprises a porous metal mesh and an oxygen evolution catalyst.

30. The iron-air battery of claim 20, wherein each anode of the plurality of anodes is in contact with a branch current collector, wherein each branch current collector is connected a primary current collector that is disposed parallel to the first surface of the oxygen reduction reaction electrode.

31. The iron-air battery of claim 20, wherein each anode of the plurality of anodes is in contact with a branch current collector, wherein the each branch current collector is connected to a primary current collector that is disposed parallel to the first surface of the oxygen reduction reaction electrode, wherein the primary current collector is disposed outside a plane defining an active area of the iron electrode, the oxygen evolution reaction electrode, and the oxygen reduction reaction electrode.

32. The iron-air battery of claim 20, wherein the oxygen evolution reaction electrode is disposed in a serpentine configuration in the plurality of channels between the plurality of anodes.

33. The iron-air battery of claim 20, further comprising a second oxygen reduction reaction electrode having a first surface facing the plurality of channels and an opposing second surface in contact with air, wherein a plane of the second oxygen reduction reaction electrode is parallel to the plane of the oxygen reduction reaction electrode.

34. The iron-air battery of claim 20, wherein the electrolyte comprises a solid oxide electrolyte, a solid polymer electrolyte, a molten salt, an aqueous solution, a non-aqueous solution, a gel, or a combination thereof.

35. The iron-air battery of claim 20, wherein the electrolyte comprises an aqueous solution of an alkali hydroxide, an organic hydroxide, or a combination thereof.

36. The iron-air battery of claim 20, wherein each anode of the iron electrode has a surface density of 1 gram of iron per square centimeter to 7 grams of iron per square centimeter relative to a direction perpendicular to the oxygen reduction reaction electrode.

37. The iron-air battery of claim 20, wherein a volume fraction of the electrolyte in the iron electrode is 0.5 to 0.9, based on the total volume of the iron electrode when fully charged.

38. An iron-air battery, comprising:
an iron electrode comprising a plurality of anodes separated by a plurality of channels, wherein the plurality of anodes is in electrical communication with each other;
an oxygen reduction reaction electrode having a first surface facing the plurality of channels and an opposing second surface in contact with air;
an oxygen evolution reaction electrode comprising a plurality of cathodes interdigitated with the plurality of anodes, wherein the plurality of cathodes is disposed within the plurality of channels in a direction perpendicular to a plane of the oxygen reduction reaction electrode, and wherein the plurality of cathodes is in electrical communication with each other; and
an electrolyte in contact with the iron electrode, the first surface of the oxygen reduction reaction electrode, the plurality of channels, and the oxygen evolution reaction electrode.

39. The iron-air battery of claim 38, wherein each anode of the plurality of anodes is in contact with an anode current collector.

40. The iron-air battery of claim 38, further comprising a separator disposed between at least a portion of the plurality of anodes and the plurality of cathodes.

41. The iron-air battery of claim 38, wherein one or more cathodes of the plurality of cathodes has an average length of 3 mm to 50 mm when measured in a direction perpendicular to a plane of the oxygen reduction reaction electrode.

42. The iron-air battery of claim 38, wherein greater than 25% of channels in the plurality of channels comprise the oxygen evolution reaction electrode disposed therein.

43. The iron-air battery of claim 38, wherein one or more channels of the plurality of channels further comprises an additive.

44. The iron-air battery of claim 38, wherein one or more anodes of the plurality of anodes has an average length of 3 mm to 50 mm in a direction perpendicular to the plane of the oxygen reduction reaction electrode, and an average width of 1 mm to 40 mm in a direction parallel to the plane of the oxygen reduction reaction electrode.

45. The iron-air battery of claim 38, wherein two or more anodes of the plurality of anodes are separated from each other by an average distance of 10 mm to 50 mm in a direction parallel to the plane of the oxygen reduction reaction electrode.

46. The iron-air battery of claim 38, wherein each anode of the plurality of anodes is in contact with a branch current collector, wherein each branch current collector is connected a primary current collector that is disposed parallel to the first surface of the oxygen reduction reaction electrode.

47. The iron-air battery of claim 38, wherein each anode of the plurality of anodes is in contact with a branch current collector, wherein the each branch current collector is connected a primary current collector that is disposed parallel to the first surface of the oxygen reduction reaction electrode, wherein the primary current collector is disposed outside a plane defining an active area of the iron electrode, the oxygen evolution reaction electrode, and the oxygen reduction reaction electrode.

48. The iron-air battery of claim 38, wherein each cathode of the plurality of cathodes is in contact with a cathode current collector, wherein the cathode current collector is disposed outside a plane defining an active area of the iron electrode, the oxygen evolution reaction electrode, and the oxygen reduction reaction electrode.

49. The iron-air battery of claim 38, further comprising a second oxygen reduction reaction electrode having a first surface facing the plurality of channels and an opposing second surface in contact with air, wherein a plane of the second oxygen reduction reaction electrode is parallel to the plane of the oxygen reduction reaction electrode.

50. The iron-air battery of claim 38, wherein the electrolyte comprises a solid oxide electrolyte, a solid polymer electrolyte, a molten salt, an aqueous solution, a non-aqueous solution, a gel, or a combination thereof.

51. The iron-air battery of claim 38, wherein the electrolyte comprises an aqueous solution of an alkali hydroxide, an organic hydroxide, or a combination thereof.

52. The iron-air battery of claim 38, wherein each anode of the iron electrode has a surface density of 1 gram of iron per square centimeter to 7 grams of iron per square centimeter relative to a direction perpendicular to the oxygen reduction reaction electrode.

53. The iron-air battery of claim 38, wherein a volume fraction of the electrolyte in the iron electrode is 0.5 to 0.9, based on the total volume of the iron electrode when fully charged.

54. The iron-air battery of claim 38, wherein the plurality of cathodes each comprises an oxygen evolution catalyst.

55. An iron-air battery, comprising:
an iron electrode in contact with an anode current collector, wherein the iron electrode comprises a plurality of channels;
an oxygen reduction reaction electrode having a first surface facing the plurality of channels and an opposing second surface in contact with air;
an oxygen evolution reaction electrode comprising a plurality of cathodes interdigitated with the iron electrode, wherein the plurality of cathodes is disposed within the plurality of channels in a direction perpendicular to a plane of the oxygen reduction reaction electrode, and wherein the plurality of cathodes is in electrical communication with each other; and
an electrolyte in contact with the iron electrode, the first surface of the oxygen reduction reaction electrode, the plurality of channels, and the oxygen evolution reaction electrode.

56. The iron-air battery of claim 55, further comprising a separator disposed between at least a portion of the iron electrode and the plurality of cathodes.

57. The iron-air battery of claim 55, wherein one or more cathodes of the plurality of cathodes has an average length of 3 mm to 50 mm when measured in a direction perpendicular to a plane of the oxygen reduction reaction electrode.

58. The iron-air battery of claim 55, wherein greater than 25% of channels in the plurality of channels comprise a cathode of the plurality of cathodes disposed therein.

59. The iron-air battery of claim 55, wherein one or more channels of the plurality of channels further comprises an additive.

60. The iron-air battery of claim 55, wherein one or more channels of the plurality of channels has an average length of 3 mm to 50 mm in a direction perpendicular to the plane of the oxygen reduction reaction electrode, and an average width of 1 mm to 40 mm in a direction parallel to the plane of the oxygen reduction reaction electrode.

61. The iron-air battery of claim 55, wherein one or more channels of the plurality of channels has an average width of 1 mm to 40 mm in a direction parallel to the plane of the oxygen reduction reaction electrode, wherein a first width that is closest to the oxygen reduction reaction electrode is 1% to 500% greater than a second width that is furthest from the oxygen reduction reaction electrode.

62. The iron-air battery of claim 55, wherein one or more channels of the plurality of channels are separated from each other by an average distance of 10 mm to 50 mm in a direction parallel to the plane of the oxygen reduction reaction electrode, when measured between centers of adjacent channels.

63. The iron-air battery of claim 55, wherein each channel of the plurality of channels independently has a rectangular prism shape, a cylindrical shape, a pyramidal shape, or a trapezoidal prism shape.

64. The iron-air battery of claim 55, wherein each cathode of the plurality of cathodes is in contact with a cathode current collector, wherein the cathode current collector is disposed outside a plane defining an active area of the iron electrode, the oxygen evolution reaction electrode, and the oxygen reduction reaction electrode.

65. The iron-air battery of claim 55, wherein the anode current collector comprises:
one or more branch current collectors disposed parallel to the plurality of channels; and
a primary current collector connected to the one or more branch current collectors, wherein the primary current collector is disposed parallel to the first surface of the oxygen reduction reaction electrode.

66. The iron-air battery of claim 55, wherein the electrolyte comprises a solid oxide electrolyte, a solid polymer electrolyte, a molten salt, an aqueous solution, a non-aqueous solution, a gel, or a combination thereof.

67. The iron-air battery of claim 55, wherein the electrolyte comprises an aqueous solution of an alkali hydroxide, an organic hydroxide, or a combination thereof.

68. The iron-air battery of claim 55, wherein the iron electrode has a surface density of 1 gram of iron per square centimeter to 7 grams of iron per square centimeter relative to a direction perpendicular to the oxygen reduction reaction electrode.

69. The iron-air battery of claim 55, wherein a volume fraction of the electrolyte in the iron electrode is 0.5 to 0.9, based on the total volume of the iron electrode when fully charged.

70. An iron-air battery, comprising:
an iron electrode in contact with an anode current collector, wherein the iron electrode and the anode current collector are arranged in a spiral configuration;
an oxygen reduction reaction electrode having a first surface facing an axis of rotation of the spiral configuration and an opposing second surface in contact with air;
an oxygen evolution reaction electrode arranged in a spiral configuration and interdigitated with the iron electrode, wherein the iron electrode and the oxygen evolution reaction electrode are at least partially bifilar; and
an electrolyte in contact with the iron electrode, the first surface of the oxygen reduction reaction electrode, and the oxygen evolution reaction electrode.

71. The iron-air battery of claim 70, further comprising a separator disposed between at least a portion of the iron electrode and the oxygen evolution reaction electrode.

72. The iron-air battery of claim 70, further comprising a second oxygen reduction reaction electrode having a first surface facing the axis of rotation of the spiral configuration and an opposing second surface in contact with air, wherein a plane of the second oxygen reduction reaction electrode is parallel to the plane of the oxygen reduction reaction electrode.

73. The iron-air battery of claim 70, wherein the electrolyte comprises a solid oxide electrolyte, a solid polymer electrolyte, a molten salt, an aqueous solution, a non-aqueous solution, a gel, or a combination thereof.

74. The iron-air battery of claim 70, wherein the electrolyte comprises an aqueous solution of an alkali hydroxide, an organic hydroxide, or a combination thereof.

75. The iron-air battery of claim 70, wherein each anode of the iron electrode has a surface density of 1 gram of iron per square centimeter to 7 grams of iron per square centimeter relative to a direction perpendicular to the oxygen reduction reaction electrode.

76. The iron-air battery of claim 70, wherein a volume fraction of the electrolyte in the iron electrode is 0.5 to 0.9, based on the total volume of the iron electrode when fully charged.

77. An iron-air battery, comprising:
an iron electrode in contact with an anode current collector, wherein the iron electrode and the anode current collector are arranged in a pleated configuration, and wherein the iron electrode comprises a plurality of channels between the pleats;
an oxygen reduction reaction electrode having a first surface facing the plurality of channels and an opposing second surface in contact with air;
an oxygen evolution reaction electrode interdigitated with the plurality of channels of the iron electrode, wherein at least a portion of the oxygen evolution reaction electrode is disposed within the plurality of channels in a direction perpendicular to a plane of the oxygen reduction reaction electrode, and wherein the oxygen evolution reaction electrode is arranged in a pleated configuration; and
an electrolyte in contact with the iron electrode, the first surface of the oxygen reduction reaction electrode, the plurality of channels, and the oxygen evolution reaction electrode.

78. The iron-air battery of claim 77, further comprising a separator disposed between at least a portion of the iron electrode and the oxygen evolution reaction electrode.

79. The iron-air battery of claim 77, wherein the oxygen evolution reaction electrode comprises a porous metal mesh and an oxygen evolution catalyst.

80. The iron-air battery of claim 77, wherein the oxygen evolution reaction electrode is arranged at a first surface of the iron electrode, and further comprising a second oxygen evolution reaction electrode interdigitated with the plurality of channels of the iron electrode, wherein the second oxygen evolution reaction electrode is arranged at a second opposing surface of the iron electrode, wherein at least a portion of the second oxygen evolution reaction electrode is disposed within the plurality of channels in a direction perpendicular to a plane of the oxygen reduction reaction electrode, and wherein the second oxygen evolution reaction electrode is arranged in a pleated configuration.

81. The iron-air battery of claim 77, further comprising a second oxygen reduction reaction electrode having a first surface facing the plurality of channels and an opposing second surface in contact with air, wherein a plane of the second oxygen reduction reaction electrode is parallel to the plane of the oxygen reduction reaction electrode.

82. The iron-air battery of claim 77, wherein the electrolyte comprises a solid oxide electrolyte, a solid polymer electrolyte, a molten salt, an aqueous solution, a non-aqueous solution, a gel, or a combination thereof.

83. The iron-air battery of claim 77, wherein the electrolyte comprises an aqueous solution of an alkali hydroxide, an organic hydroxide, or a combination thereof.

84. The iron-air battery of claim 77, wherein each anode of the iron electrode has a surface density of 1 gram of iron per square centimeter to 7 grams of iron per square centimeter relative to a direction perpendicular to the oxygen reduction reaction electrode.

85. The iron-air battery of claim 77, wherein a volume fraction of the electrolyte in the iron electrode is 0.5 to 0.9, based on the total volume of the iron electrode when fully charged.

86. A method of forming the iron-air battery of claim 1, the method comprising:
forming an iron negative electrode material onto an anode current collector to form the iron electrode comprising a plurality of channels;
disposing the oxygen evolution reaction electrode into one or more channels of the iron electrode; and
assembling the oxygen reduction reaction electrode having the first surface facing the iron electrode and the opposing second surface in contact with air to form an electrode assembly.

87. The method of claim 86, wherein the forming comprises compressing the iron negative electrode material onto a current collector to form the plurality of channels disposed in the iron electrode.

88. The method of claim 87, wherein the forming further comprises sintering.

89. The method of claim 86, further comprising adding the electrolyte to the electrode assembly.
